(19) United States
(12) Patent Application Publication
(10) Pub. No.: US 2002/0019749 A1
(43) Pub. Date: Feb. 14, 2002

(54) Method and apparatus for facilitating delivery of medical services

(76) Inventors: Steven Becker, Houston, TX (US); Frank Bowlin, Aptos, CA (US)

Correspondence Address: MICHAEL O. SCHEINBERG, P.O. BOX 164140, AUSTIN, TX, 78716-4140, US

(21) Appl. No.: 09/893,359

(22) Filed: Jun. 26, 2001

Related U.S. Application Data
(60) Provisional application No. 60/214,607, filed on Jun. 27, 2000.

(51) Int. Cl. G06F 17/60

(52) U.S. Cl. 705/2

(57) ABSTRACT

An electronic system facilitates the clinician-patient encounter and serves as a single point of integration for all electronic health care information systems. A physician selects a diagnosis, which is converted from the physician's preferred terminology to a standard ICD diagnosis. The system then proposes a preferred treatment appropriate to the selected diagnosis. The physician can change any items of the proposed treatment plan, with changes being checked against payor rules, prior patient information and selected authorities' guidelines. If a diagnosis or treatment element is not authorized by the payor for the selected diagnosis, the system notifies the physician, allowing changes or offering electronic request for payor authorization. Additionally, the system may indicate those diagnoses for which payor allows said elements, allowing the physician to choose a diagnosis that is consistent with the patient's symptoms and supports the desired treatment. Upon accepting a diagnostic and treatment plan, the plan elements are preferably carried out automatically. For example, payor authorizations are requested as necessary, prescriptions are transmitted to the patient's preferred pharmacy, laboratory tests are ordered, and tests, referrals, and appointments are scheduled electronically.

This application claims priority from U.S. Prov. App. No. 60/214,617 filed Jun. 27, 2000, which is hereby incorporated by reference.

### TECHNICAL FIELD OF THE INVENTION

The present invention relates to the field of health care delivery and, in particular, to an electronic system that facilitates the clinician-patient encounter and that can serve as a single point of integration for electronic health care information systems.

### BACKGROUND AND SUMMARY OF THE INVENTION

To curtail the rising cost of providing health care, many attempts have been made to use computers to facilitate the delivery of health care services. These computer systems have generally been poorly aligned with the physician's work flow and have not been widely adopted.

Physicians spend most of their workday seeing patients. Over centuries, physicians have derived a model of the physician-patient encounter (“the Encounter”) that divides it into four discrete parts, with each part producing specific information. This model has been almost universally adopted by health care providers worldwide. The information resulting from the parts has different appellations, but falls into the following segments:

Historical health information, including symptoms described by the patient

Physical examination observations, including objective findings by the physician

Assessment, including diagnosis, differential diagnosis, working diagnosis, and

Plan, which may include:

Diagnostic or treatment procedures

Scheduling of procedures, referral and/or reassessment

Information/education for patients

Projected care plan and other processes and functions appropriate to each given diagnosis)

In most English-speaking countries, this information model is referred to by the acronym SOAP. “S” refers to symptoms (History); “O” refers to objective findings (Physical examination findings); “A” refers to assessment (Diagnosis); and “P” refers to plan or “care plan.”

To better understand the process and flow of the encounter, the applicants have differentiated aspects of the encounter into “Descriptive” and “Functional” data. Descriptive data has no further function than subsequent review. Functional data is recorded for later review, but is also created as a result of the Encounter and is used to initiate one or more processes that result from the encounter.

Using the SOAP information model, “S” and “O” (History and Physical examination findings) are exclusively descriptive data. “A” and “P” can be considered Functional data, as they directly result in the initiation of one or more processes.

Efforts to integrate computer technology into the physician-patient encounter have largely focused on digitally recording the historical data (S) and physical examination data (O)—the descriptive data—learned during the Encounter for later review or for electronic transmission and reproduction. These electronic medical records systems do not facilitate the encounter itself Existing electronic medical records are highly structured to accommodate the complexity of medical practice, whereas physicians' medical practices are typically highly individualized. The resulting conflict between personal work style and structured electronic medical record system generally disrupts the encounter, rather than facilitate it as intended. Therefore, such systems typically add minutes of administrative time to each physician-patient encounter. (Adding even two minutes to each encounter can add an extra hour to the physician's day.) Moreover, the operation of such systems, not being intuitively obvious, requires the physician to spend time learning the system, and most physicians are not willing to add the required training time to their busy schedules. Because of these limitations, such systems have not gained wide acceptance in the medical community.

The need for productivity-enhancing electronic tools during the Encounter has become increasingly apparent in today's health care business environment. Efforts to contain cost-of-care and show profit have forced physicians to become more businesslike in their day-to-day practice of medicine, providing motivation to increase efficiency and decrease overhead wherever possible. At the same time, oversight by insurance providers has increased the administrative burden of practicing medicine. Each physician-patient encounter can require the physician to generate between four and twelve forms, which take an average of two to ten minutes to complete. These forms include requisitions, charge sheets, prescriptions, labels, patient information, authorization requests, referral forms, follow-up instructions, schedules etc. Despite the need to mitigate the administrative burden, current computer tools do not enhance productivity of the basic transaction of the health care industry: the physician-patient encounter.

Some attempts have been made to computerize specific aspects of health care delivery apart from the clinical patient record. These limited attempts, or “point solutions,” include for example, expert systems that assist a physician in reaching a diagnosis or in selecting a proper drug dosage. Such systems are not popular with physicians because, like the clinical patient record systems, they disrupt the physicians' work flow, thereby decreasing productivity. Moreover, physicians typically do not require the assistance of an expert system to reach a diagnosis.

Prior electronic art, while offering enhanced capabilities, has proven to be less efficient than pen and paper. The physician's need for efficiency outweighs the need for improved functionality. Thus, the need for a system to electronically facilitate the physician's work day remains largely unfulfilled, and physicians rely primarily on handwritten documentation.

Moreover, because computers are not integrated into routine medical practice, physicians remain largely disconnected from the increasing realm of health care information available via the Internet and other computer-accessible sources.

The invention is able to enhance efficiency during the Encounter making the invention an essential component of the physician's practice workflow. This, in turn, will enable the invention to serve as a single point of integration for a vast array of useful electronic tools and information.

An object of the invention is to increase the efficiency and effectiveness of the Encounter, that is, the contact, in person, over a telephone, or otherwise, between a clinician, such as a physician, nurse practitioner, or physician's assistant, and a patient seeking health-related services from the clinician.

Another object of the invention is to provide a graphic interface that automates the clinician's process of selecting the desired convergence of diagnosis and care plan.

A further object of the invention is to automate health care administrative tasks such as completion of forms, requisitions, transmittal memos, etc. to improve the accuracy of information and reduce errors in the provision of health care.

Yet another object of the invention is to promote a uniform standard of care by using authoritative guidelines to assist a clinician in reaching a diagnosis and care plan.

Still another object of the invention is to provide a single point of integration for data and expert systems related to patient healthcare, the single point of integration being an integral component of the clinician's workflow and readily accessible to the clinician to facilitate the Encounter.

Yet a further object of the invention is to provide a graphic interface that allows the use of user-defined diagnosis terms which may be converted by the invention to standard industry terms.

Another object of the invention is to provide selection of alternate appropriate diagnosis terms when chosen diagnosis terms do not conform to authoritative guidelines for initiation of diagnostic and treatment procedures.

Still a further object of the invention is to provide a software mechanism that facilitates the process of converging from working diagnoses to final diagnoses, with treatment and diagnostic choices based on a payor or other authority's acceptable guidelines.

Yet another object of the invention is to reduce or eliminate the need for paperwork attendant to the Encounter and automate the creation of necessary paperwork that is required.

Still another object of the invention is to automate the provision of health care by electronically transmitting to target information systems requests for carrying out diagnostic and treatment plans, including requests for authorizing care, filling prescriptions, scheduling of treatment or diagnostic procedures, and for creating paper forms, labels, requisitions and other identifying documents and information.

Yet a further object of the invention is to provide an ergonomic voice, touch and/or text-accessed interface that provides enhanced efficiencies in the process and flow of medical care.

Still a further object of the invention is to provide a system that provides for effective, incremental transition from paper-based to computer-based medical care support for most physicians, despite a wide range of attitudes toward computer automation.

Yet another object of the invention is to provide a system that allows for the seamless convergence of systems such as electronic medical records, expert software systems, and other healthcare-related and non-healthcare-related electronic data.

Still another object of the invention is to provide a mechanism for providing targeted information and advertising to clinicians about medical and non-medical products.

The present invention is a method and apparatus for enhancing the Encounter by automating and implementing medical care tasks.

The information used in the Encounter can be classified into two groups: “descriptive data,” such as historical data and physical examination findings, and “functional data,” such as diagnoses and care plans. Applicants have discovered that a primary reason prior efforts to automate the Encounter have met with limited success is because of a failure to differentiate between processing descriptive data and functional data. Descriptive health-related data can comprise an unlimited number of combinations of terms and is, therefore, inherently intractable. To handle descriptive data, each individual clinician develops his or her own preferred terminology and approach to recording the data, ranging from transcription to handwriting, to hiring staff to write or record for them. Automating such unruly data has not been efficient. Moreover, because of the wide variety of methods adopted by individual clinicians for handling such data, efforts to automate the collection of descriptive data typically disrupt the established work patterns of the clinicians.

On the other hand, functional data, such as diagnoses and care plan elements, are described by a limited set of enumerable terms, such as the diagnoses promulgated in the International Classification of Diseases, currently in its ninth edition (ICD-9). Similarly, care plan items, such as ordering a specific test or carrying out certain procedures, can be described by a limited number of enumerated terms. Even prescription of medication follows codified rules and highly defined data sets. Moreover, while descriptive data is critically important to the thought processes of the clinician in assessing the patient, and is used for later review by clinicians, some payors (insurance companies) and occasionally, attorneys, the functional data is more directly related to the actual practice and business of medicine. Whereas prior art electronic systems have concentrated on the collection and storage of descriptive data by a singular method unique to each software system, applicants have discovered that requiring each unique clinician to electronically enter descriptive encounter data in such a singular, non-customary manner typically detracts from the clinician's efficiency. Conversely, entering functional data by the process described herein can increase efficiency by assisting the clinician to specify the desired diagnosis and suitable care plan, and then facilitating the implementation of the care plan.

Thus, in a basic embodiment, the clinician is required to enter only functional data. Capturing descriptive data, while not essential to facilitating the Encounter in accordance with the present invention, is still a necessary aspect of the practice of medicine. It can optionally be collected and optionally integrated with the inventive system in a variety of ways, chosen by each individual user. These choices may include continued use of the paper chart record, capture of computer-tablet-inscribed handwriting image, handwriting- or voice- recognition/transcription, or integration of existing electronic medical records (EMRs) with the present invention.

According to one aspect of the present invention, a novel user interface, referred to as the CareGrid™ interface, requires only functional data. The CareGrid™ interface allows a clinician to automate a portion of his work flow, without constraining him to a rigid process flow and without requiring him to perform additional tasks, such as recording descriptive data, that would disrupt his work flow. To use the CareGrid™ interface, the clinician determines, typically without electronic assistance, a diagnosis. The clinician enters the diagnosis using an input device that is part of a clinician access device. The clinician access device also includes an output device that automatically displays to the clinician a proposed Care Plan composed of Care Plan elements, such as treatment or diagnostic procedures, corresponding to the diagnosis. The clinician selects one or more Care Plan elements, and if necessary, changes or adds additional Care Plan elements. In some situations, the clinician may be notified of the need to change the diagnosis(i/e)s in order to comply with authoritative guidelines. In such instances, the system can assist the clinician in selecting diagnosis(i/e)s that are appropriate to the patient's care and that will comply with authoritative guidelines and enable said care plan elements' selection.

Thus, the CareGrid™ interface requires only functional information to be input by the clinician and produces from the input additional or modified functional information. Preferably, one or more of the Care Plan elements are implemented automatically upon acceptance by the clinician. For example, a laboratory test may be ordered and scheduled, a prescription transmitted to a pharmacy, billing information may be transmitted electronically to appropriate systems—or appropriate paper forms may be printed or automatically faxed.

In a preferred embodiment, the clinician access device is a handheld computing device, such as a tablet, that has a touch sensitive screen and is in data communication with a computer network. Additional enhancements may include a microphone for verbal input. The screen displays the CareGrid™ interface, which displays diagnoses and Care Plan elements in contiguous cells arranged in rows and columns. Diagnoses and associated Care Plan elements are arranged in one or more rows, with each row segmented by category of care such as prescription, tests, etc.

Upon beginning the process, diagnoses most commonly used by those in the clinician's specialty are requested by a screen touch or verbal command and are presented to the clinician in a logical arrangement. The clinician may also manually or verbally enter a diagnosis rather than picking one from the presented list. The diagnosis selected can be in the clinician's own preferred terminology, such a diagnosis is referred to as a colloquial diagnosis. The system recognizes the clinician's colloquial diagnosis and translates it to a corresponding standard or formal diagnosis, such as a diagnosis from the latest edition of the ICD. If the clinician's colloquial diagnosis corresponds to more than a single standard diagnosis, the system presents to the clinician those multiple standard diagnoses and the clinician can chose the appropriate one.

Upon selection, the chosen diagnosis is displayed in the first cell in a row of the CareGrid™ interface, and a proposed diagnostic and treatment plan, referred to as a Care Plan, is displayed, including one or more proposed Care Plan elements displayed in each column of the CareGrid™ interface, if appropriate for the diagnosis. The Care Plan elements displayed can be determined on the basis of, for example, numeric precedent of previous selections by the clinician, or a fixed choice defined by the clinician, medical authority, or payor rules. The clinician can accept the displayed elements or touch a cell to obtain a list of other Care Plan elements, presented in a logical order. As with the diagnosis, the clinician can select a presented Care Plan element or select an element by manually entering it.

If the clinician has selected a diagnostic or treatment option that is not authorized by a payor or other authority for the selected diagnosis, the clinician is notified and can request a list of related diagnoses that do support the desired treatment. The clinician can work back and forth between diagnosis and treatment to determine a diagnosis that is consistent with the examination findings and that supports the desired Care Plan. After the clinician has accepted a diagnostic and treatment plan, one or more of the Care Plan elements are preferably initiated automatically. For example, a prescription may be printed or transmitted to a pharmacy. The clinician is preferably warned if a selected plan element potentially conflicts with an existing patient condition or with an existing or proposed treatment. By allowing the clinician to work in either direction between diagnosis and Care Plan, the system adapts itself to the clinician's desired work flow, rather than imposing a work flow upon the clinician. By providing guidance in the selection of Care Plan options, the invention promotes a uniformly high standard of care among clinicians.

By not requiring the clinician to input descriptive data, such as history and examination findings, and by using functional data to assist the clinician to initiate a diagnostic and treatment plan, the present invention facilitates the Encounter and makes the clinician's work easier, more accurate, and more productive. Providing a computer tool that will thus enhance the clinician's workflow is the key to bringing the full benefit of computer technology into the health care arena. Once the clinician accepts a computer as a valuable tool in the Encounter, the tool can be used as a focal point for a vast array of information to and from the clinician, which may include electronic medical records if desired by the physician.

A system of the present invention can be sufficiently flexible to allow various health care functions to be integrated incrementally into the system. Thus, the clinician can use the CareGrid™ interface alone, or can integrate, at a comfortable rate, all aspects of health care technology available to the clinician. Modular components can be added to provide additional functionality as desired by the clinician. Rather than requiring that a clinician change systems, such as scheduling and billing software systems, that he is successfully using in his office, the inventive system preferably uses an application programming interface (API) that allows the various existing systems to be integrated with the present invention to present a single, logical interface to the clinician.

For example, by integrating the office scheduling software, the clinician's schedule can be downloaded to the clinician interface device for display to the clinician. The clinician can then select a patient from the schedule. When electronic medical records have been integrated, the clinician interface device can display the selected patient's medical records.

The clinician access device is preferably in data communication through the office server with third party servicing networks, such as pharmacy networks. For example, when the clinician selects a medication as a Care Plan element, a prescription can be transmitted to the patients' preferred pharmacy. Similarly, laboratory tests may be ordered, appointments with specialists may be arranged, etc.

The invention can integrate processes that are not efficiently automated, such as history and physical data recording, loosely, fully or not at all—as the clinician chooses. Such flexibility allows the natural transition process from paper medical record or voice transcription to electronic storage, such as by direct handwriting image retention, cognitive handwriting or voice recognition, or other data entry modalities. Clinicians who are comfortable dictating history and examination findings can continue to dictate using, for example, a microphone integrated into the clinician access device. The recorded findings can be downloaded to a transcriptionist for transcribing, or the recording can be converted to text by voice recognition software, with a transcriptionist proofreading and correcting any errors made by the voice recognition software. The clinician's findings can then be transmitted to the handheld device for display to the clinician, who may enter changes or his acceptance of the findings into the handheld device using for example, a touch screen or stylus.

By integrating the billing and insurance aspects of the office management software the clinician can see the patient's insurance coverage upon calling up a patient record. Network access to the patient's insurer will allow the clinician to see all elements of the patients' coverage for medications, specialists and facilities.

Other point solutions, such as expert systems for dosage calculation, differential diagnosis selection, and quality assurance or utilization management (cost-effectiveness) guideline programs that are becoming increasingly important in a rapidly evolving healthcare environment, can be integrated into the present invention. Virtually any data, from patient information to authoritative medical treatises, can be made instantly available to the clinician without disrupting the Encounter. Similarly, the clinician can contact a range of services with a word or touch of a screen. Thus, by providing a tool to the clinician that actually facilitates the Encounter, the entire world of electronic information and transactions opens up to the clinician.

The CareGrid™ aspect of the present invention is based upon a process algorithm that defines the Encounter and the unique graphic interface that most effectively relates those processes whose automation most benefit the clinician, while avoiding the primary inclusion of those processes whose automation decrease efficiency of the encounter. Other variations, additions or subtractions may accomplish similar functions and still be within the scope of the invention, but the unique CareGrid™ graphic interface defines the maximum efficiency obtainable for automation of the Encounter by use of a computer graphic interface. The CareGrid™ interface is a simple presentation of a complex convergence of data; easy to use, but powerful.

The universality of the CareGrid™ interface's unique presentation is also evident in its ability to enhance processes and increase efficiency and quality of the encounter in other countries, where healthcare business practices are very different from those in the United States. For example, in Canada and Britain, time saved by the clinician results in more patients being seen and increased potential cost to the government payor. Nevertheless, the value offered by guiding the clinician to less expensive, better quality practice methods and treatments saves these government payors far more than the added expense of increased patient care volume.

Numerous prior efforts to use computer automation to enhance the encounter have proven inefficient because they have ignored the individuality of physicians and have routinely followed the classic SOAP encounter configuration. No prior software or computer system has delineated the difference between descriptive and functional data, a nor has any system presented said functional data in an interactive graphic interface that provides for efficient selection of all Care Plan elements. Taken together, these logical components of the CareGrid™ interface offer a unique and valuable tool to the medical profession for the first time.

The foregoing has outlined rather broadly the features and technical advantages of the present invention in order that the detailed description of the invention that follows may be better understood. Additional features and advantages of the invention which form the subject of the claims of the invention will be described hereinafter. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of the functional components of the clinician access device.

FIG. 2 shows a perspective view of a top view of the preferred clinician access device of FIG. 1.

FIG. 3 is a flow chart showing the operation of the preferred clinician access device of FIG. 1.

FIG. 4 shows a basic screen displayed upon powering up the handheld computing device of FIG. 2.

FIG. 5 shows a screen with a list of the day's appointments.

FIG. 6 shows a screen displaying a preferred embodiment of a clinician interface in accordance with the present invention

FIG. 7A is a flow chart showing a preferred process for selecting a diagnosis.

FIG. 7B is a flow chart showing a preferred process for selecting Care Plan elements.

FIG. 8 is a flow chart showing a preferred process for selecting alternative or additional Care Plan elements that occur if the clinician does not accept the suggested Care Plan elements.

FIG. 9 shows the clinician interface of FIG. 6 with a personal information table displayed.

FIG. 10 shows a the clinician interface of FIG. 6 with several tables displayed.

FIG. 11 shows the screen of FIG. 4 with the communications features displayed.

FIG. 12 shows the communications features of FIG. 11 displayed along with the user interface of FIG. 6.

FIG. 13 shows the screen of FIG. 4 with the prescription features displayed.

FIG. 14 shows the screen of FIG. 4 with the payor features displayed.

FIG. 15 shows the screen of FIG. 4 with the goods and services feature displayed.

FIG. 16 shows the screen of FIG. 4 with the news feature displayed.

FIG. 17 is a block diagram showing the hardware used to implement an embodiment of the present invention.

FIGS. 18A, 18B, 18C, and 18D show the some of the functional interrelations and flows of information between the components of FIG. 17.

### DETAILED DESCRIPTION OF THE PREFERRED EMBODIMENTS

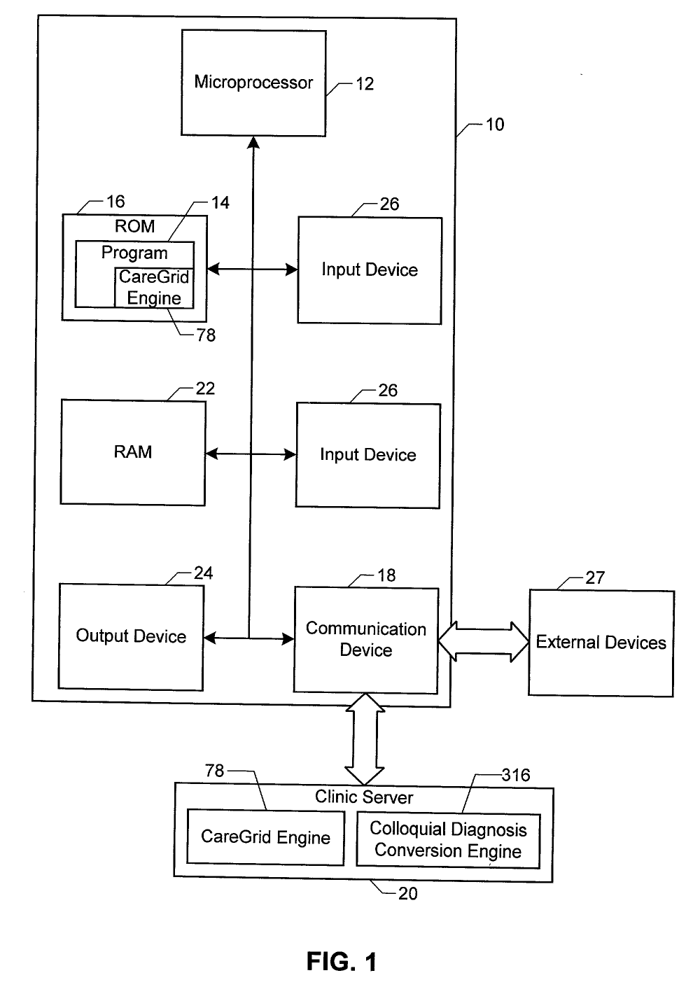

FIG. 1 is a block diagram showing the functional components of a preferred clinician access device 10 used in connection with the present invention. Clinician access device 10 includes a microprocessor 12 executing a computer program 14 stored at least in part in a read only memory (ROM) 16 and carrying out many of the steps of the present invention. Clinician access device 10 includes a communications device 18 for communicating with a clinic server 20 on which may reside additional portions of the computer program and data used in carrying out the invention. Clinician access device 10 also uses a random access memory (RAM) 22 for temporary information storage.

Clinician access device 10 also includes at least one output device 24 and associated circuitry for communicating information to the clinician, as well as one or more input devices 26, such as a touch sensitive screen and a microphone, with associate circuitry for receiving information from the clinician. Output device 24 can provide information to the physician visually, audibly, or in any combination of ways. Input devices 26 can allow input in any number of ways, such as by a touch screen, keyboard, voice capture, voice data recognition, voice command recognition, handwriting image capture, cognitive handwriting recognition, or any other way or combination of ways of receiving communications to the physician. Communication device 18 or a different communication device can optionally support data ports for connection external devices 27, such as thermometers or blood pressure measurement devices.

The clinician access device 10 could comprise, for example, a desk-top, lap-top, tablet, or other type of computer. The preferred embodiment of clinician access device 10 may change as technology evolves. The components that comprise clinician access device 10 do not need to be physically incorporated into a single unit. For example, a wall display or speaker could be used as the output device. A microphone mounted in a room could be used as an input device, and additional memory may reside off the device. Any type of devices that can provide information to the clinician and receive input from the clinician can be used as a clinician access device without departing from the scope of the invention as defined in the claims appended hereto.

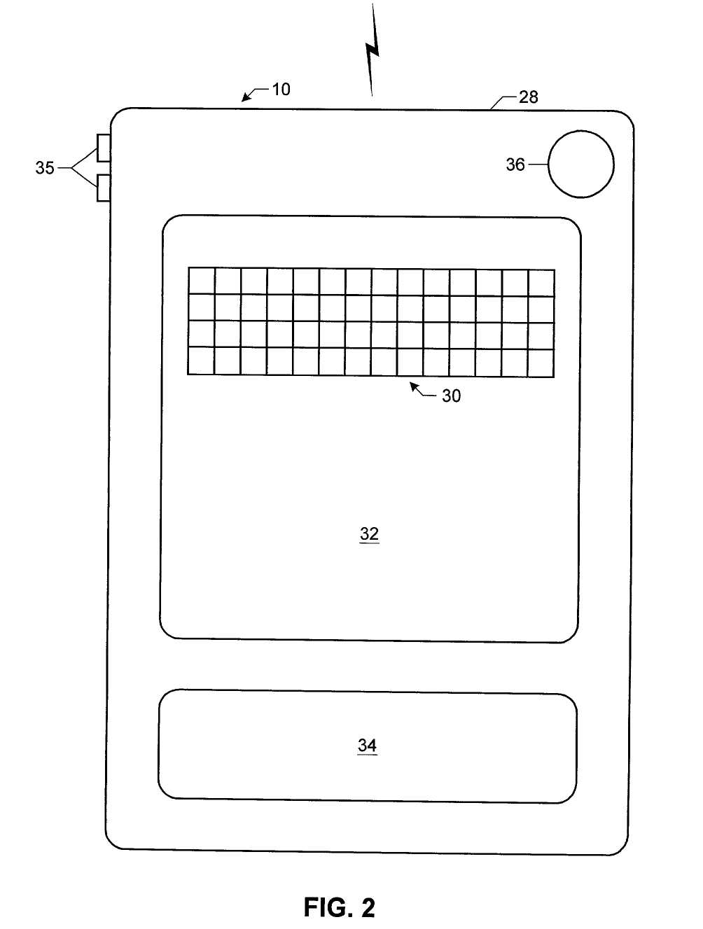

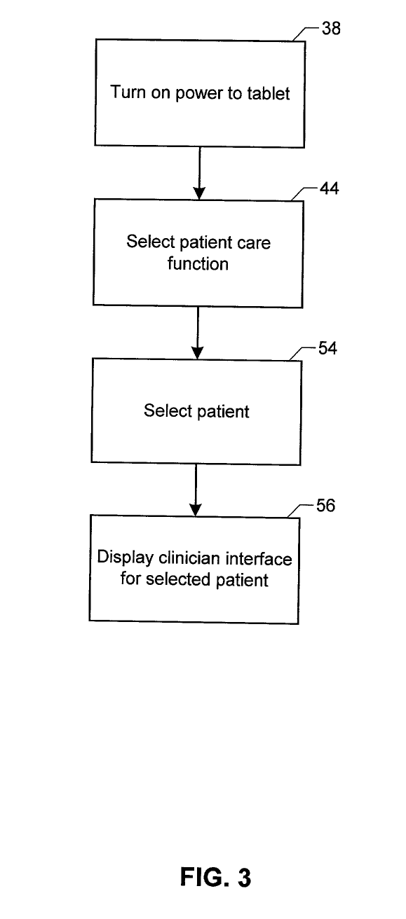

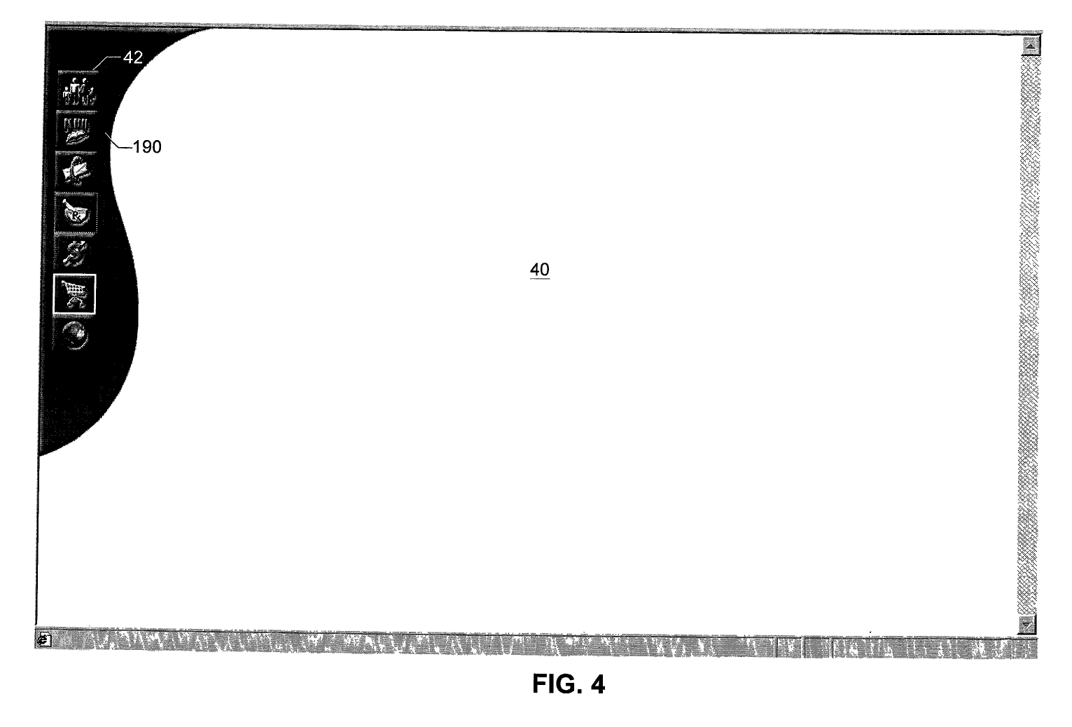

FIG. 2 shows a preferred clinician access device 10 in the form of a handheld computing device or tablet 28 on which clinician interface 30 is displayed. Tablet 28 include a touch sensitive screen 32 for selecting items from a displayed screen, a pen stroke area 34 (which may be the entire screen 32 ) for entering information using pens strokes, and a microphone 36 for accepting speech commands or data from the clinician. One or more connection ports 35 allow direct connection of one or more devices such as an electronic thermometer or blood pressure measuring device. FIG. 3 is a flow chart showing the steps by which the clinician accesses the features of a system incorporating the present invention. In step 38, the clinician turns on the power to tablet 28. FIG. 4 shows a basic screen 40 displayed upon powering up tablet 28. The functions of the various buttons of screen 40 will be explained in detail below. Each user will require one or more passwords for software access. Certain types of information pertaining to other users or patients may require specific passwords allowing access only by appropriate individuals.

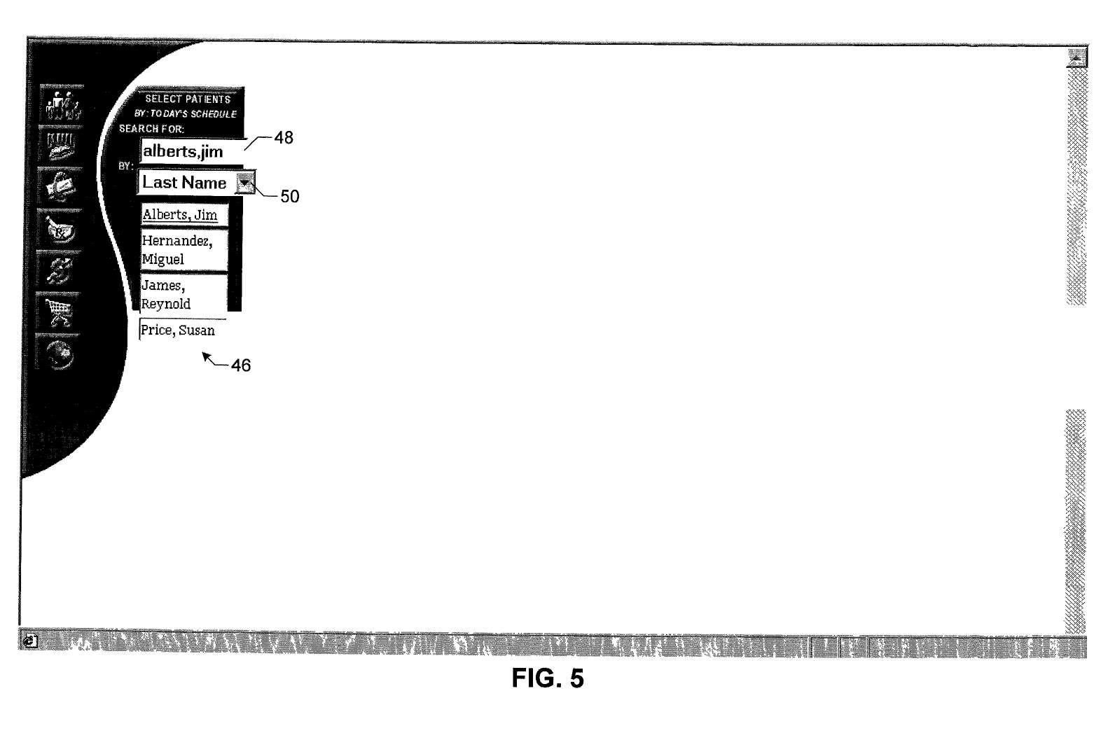

Upon selection of a Patient Care Button 42 in step 44, a list 46 of the day's appointments is displayed as shown in FIG. 5. The clinician can enter a patient's name, select a name from the schedule, or perform a search to locate a patient. Below a text box 48 for entering a search criteria is a button 50 that provides cascading menu choices to allow the clinician to specify any of various parameters to use for searching the parameters, including encounter time, date, frequency, last name, first name, phone number, disease, age, occupation, employer, physician or payor. Search results can be specified as requiring an exact match to the search term, beginning with the search term, or containing the search term. There may also be a “Print” button below the list, which will print the list, along with the criteria used for the search which returned this list. A sort field may be provided to allow the user to determine the order, such as alphabetical or chronological by appointment, in which patients are displayed. Once the user performs a search, the results are displayed in a user-defined number of items from which the user can select the desired entry. If additional names are available, a “More” button may be displayed at the bottom of the list as appropriate. Some searches may produce intermediate results requiring an intermediate selection, such as searching for a patient by employer may require specifying whether an employer beginning with “John” should return employees of John Mansville or Johns Hopkins. The clinician can also be presented with means, such as arrow buttons or a calendar, for displaying patients scheduled for different days. Once the list of desired patients is displayed., the user may select a patient for the remainder of “Patient Care” activities.

If a list is to include patients of a practitioner other than the user, the list may also include an indication of the healthcare provider for whom the patient list is shown. If a search by clinician is requested, a pop-up list showing all the providers in the clinic from which to choose is available, including preferably a “clinic” option to show all patients for the entire clinic. Displaying other than one's own patients requires appropriate authorization.

In step 54, a patient is selected by voice command or by touching the patient's name on the screen in a schedule or list as described above. If the selected patient does not have a scheduled appointment for the current day, that patient will become an entry in a “Non-scheduled patient encounters” list to facilitate future activities with that patient. The “Non-scheduled patient encounters” list will be cleared at the beginning of the following workday. Upon selecting a patient, a CareGrid™ interface 30 is displayed for the selected patient in step 56.

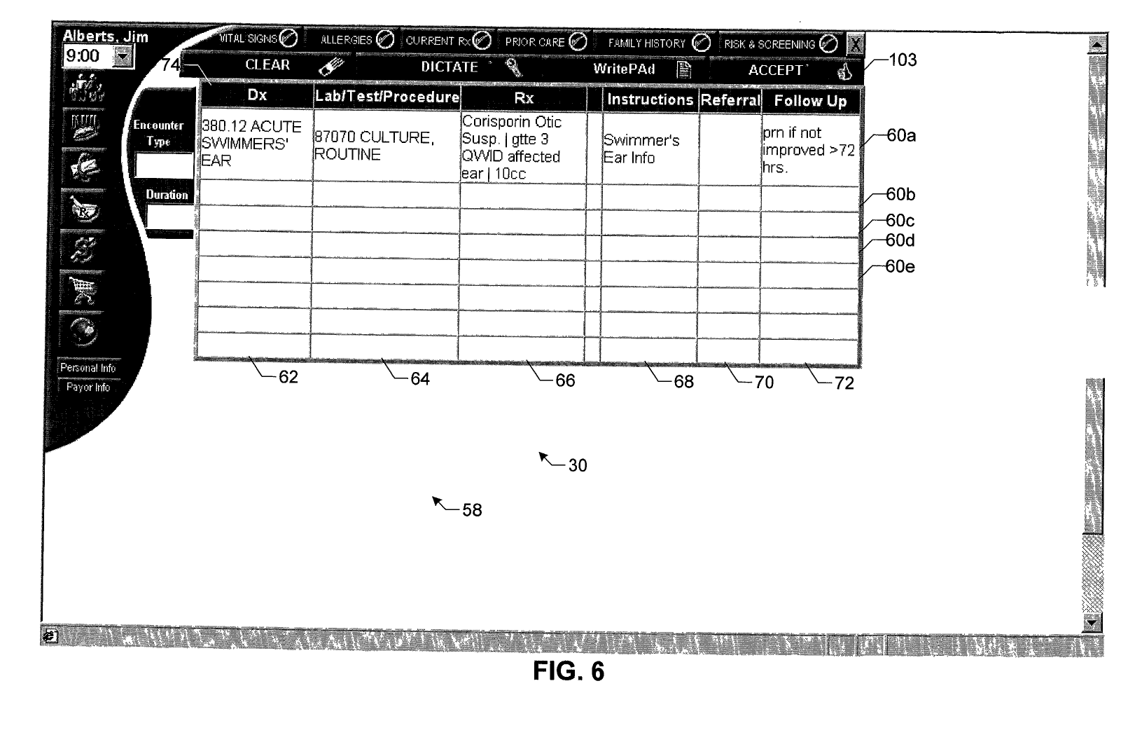

FIG. 6 shows a preferred embodiment of a clinician interface screen 58 that includes a CareGrid™ interface 30 in accordance with the present invention. CareGrid™ interface 30 is presented to the clinician by the clinician access device 10 after a patient has been selected. Clinician interface 30 includes multiple diagnosis rows, such as rows 60a, 60b, 60c, 60d, 60e, and 60f, referred to collectively as rows 60, and a diagnosis (Dx) column 62, a Lab/Test/Procedure column 64, a prescriptions (Rx) column 66, an instructions column 68, a referral column 70, and a follow-up column 72.

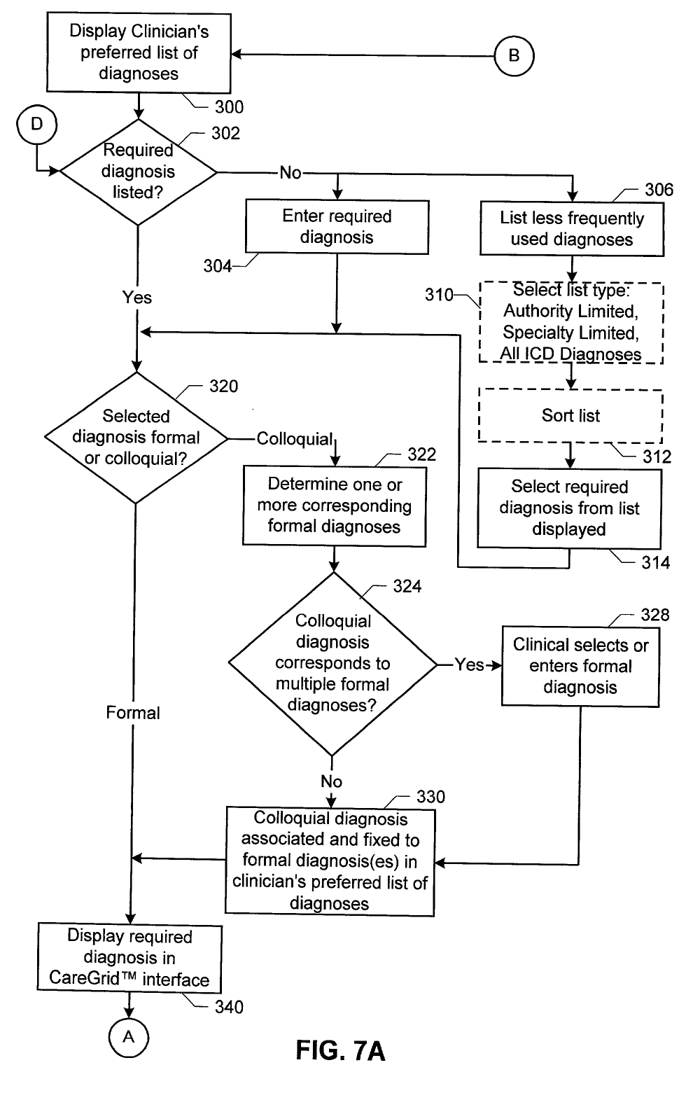

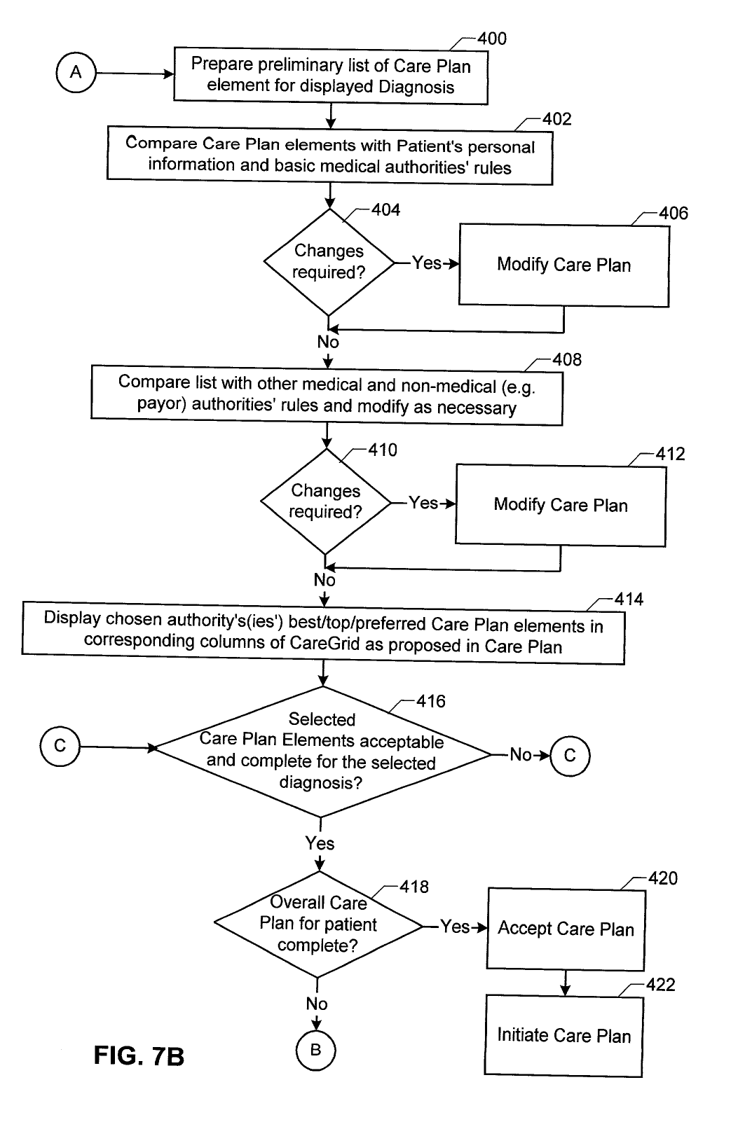

FIG. 7A is a flow chart that describes the working of the clinician interface 30. The physician touches a diagnostic column heading 74 (FIG. 6), and in step 300, the clinician access device 10 displays the clinician's preferred list of diagnoses, optionally along with the standardized ICD code for the diagnosis. The list may comprise, for example, the top fifty or one hundred diagnoses in the clinician's area of practice arranged alphabetically. In step 302, the clinician determines whether the required diagnosis is on the displayed list. If the required diagnosis is not on the list, for example, because it is outside the clinician's specialty, the clinician either enters the required diagnosis in step 304 using the alphanumeric data entry capability of pad 28 or retrieves in step 306 a list of less frequently used diagnoses. If the clinician retrieves a list, he can optionally specify in step 310 the type of list, for example, whether the list includes all diagnoses in the ICD compendium or is authority or specialty limited. In step 312, the clinician can optionally sort the list on a selected criteria such as by specialty or affected body system. In step 314, selects a diagnosis, preferably by touching the screen.

Some of the listed diagnoses may be in colloquial terminology that is preferred by the clinician. Colloquial diagnoses can include those that are used by clinicians generally, as well as those that are specific to and entered for an individual clinician. A colloquial diagnosis conversion engine 316 (FIG. 1) computer program, operating on tablet 28, clinic server 20, or both, determines in step 320 whether the selected diagnosis is a colloquial diagnosis. If a colloquial diagnosis has been selected, colloquial diagnosis engine 316 in step 322 uses translation tables to map the colloquial diagnoses to one or more a formal diagnosis, such as those listed in the ICD thereby determining one or more corresponding formal diagnoses. If colloquial diagnosis conversion engine 316 determines in step 324 that the colloquial diagnosis corresponds to more than one formal diagnosis, a list of the formal diagnoses is provided to the clinician who selects in step 328 the appropriate one of the displayed diagnosis.

In step 330, the colloquial diagnosis is associated with the selected formal diagnosis and stored in clinician's list of preferred diagnoses, so that the chosen formal diagnosis will be the default choice corresponding to the colloquial diagnosis. After the formal diagnosis is determined, the selected diagnosis is inserted in step 340 into the first vacant row 60 of CareGrid™ clinician interface 30 in the diagnosis column 62. CareGrid™ engine 78 then uses a diagnosis/treatment/prescription database to determine an appropriate preferred Care Plan corresponding to the diagnosis.

The Care Plan consists of zero or more preferred Care Plan elements that may include, for example, further diagnostic procedures, such as laboratory test or radiological procedures, prescription or over the counter medications, in-office or out-of-office referrals, general care instructions, hospitalization, etc. FIG. 7B shows that in step 400, CareGrid™ engine 78 prepares for the selected diagnosis a preliminary preferred Care Plan comprising Care Plan elements for each of the columns of the CareGrid™ interface 30. In step 402, CareGrid™ engine 78 compares the preliminary Care Plan elements with data personal to the patient and applies basic medical authority rules to verify the appropriateness of the preliminary Care Plan elements. For example, CareGrid™ engine 78 may check for any contraindications, such as drug allergies or drug interactions. CareGrid™ engine 78 can also use the patient's personal information to compute drug dosages appropriate for the patient's age, sex, weight, etc.

If CareGrid™ engine 78 determines in step 404 that any changes to the Care Plan are required, those changes are made in step 406. In step 408, the Care Plan elements are compared with rules propounded by other medical and non-medical authorities, such as payor guidelines. If CareGrid™ engine 78 determines in step 410 that any changes are required, appropriate changes to the Care Plan are made in step 412. After reviewing and modifying as necessary the preliminary Care Plan in steps 402, 406, 408 and 412, the resulting Care Plan elements comprise a proposed Care Plan, and the Care Plan elements are referred to as proposed Care Plan elements.

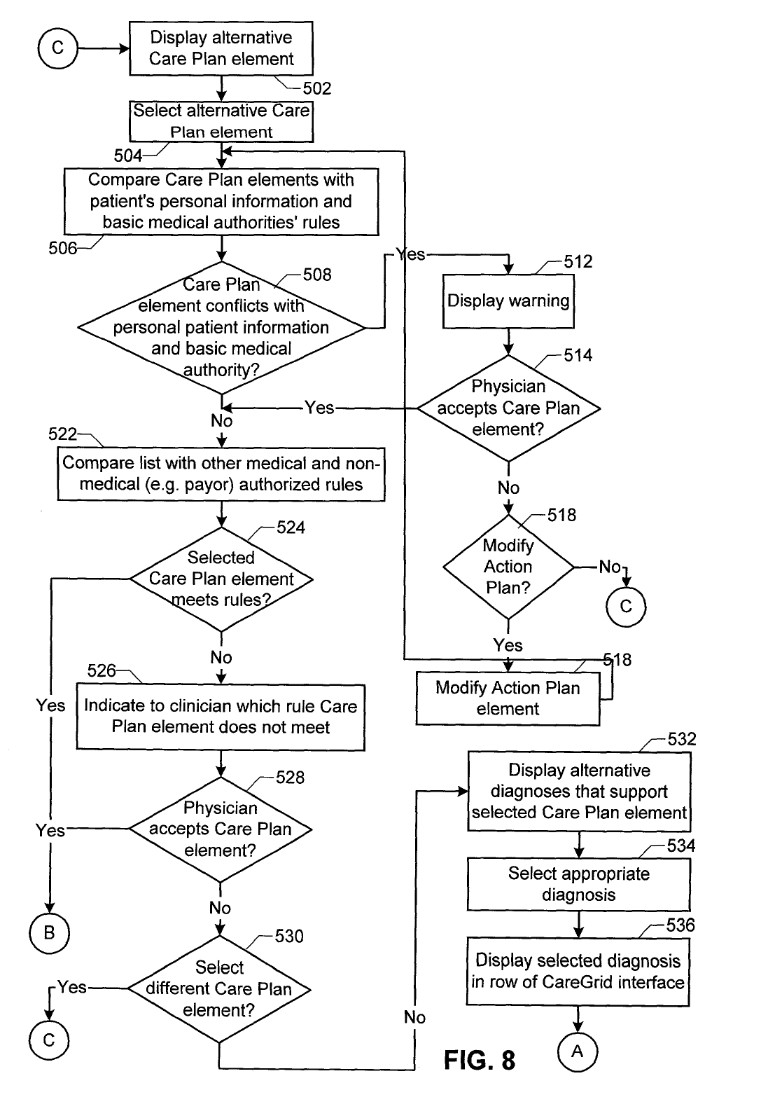

The proposed Care Plan elements corresponding to the selected diagnosis are inserted In step 414 into the CareGrid™ interface row 60 that has the selected diagnosis in column 62. The proposed Care Plan elements are inserted as a proposed Care Plan into lab test and procedures column 64, prescriptions column 66, instructions column 68, and follow-up column 72, as required. In step 416, the clinician determines whether the proposed Care Plan is acceptable and complete for the selected diagnosis. If the clinician determines in step 416 that some of the proposed Care Plan elements are not acceptable or that additional elements are required for the diagnosis, he begins the process of selecting alternative or additional Care Plan elements by moving to step 502 (FIG. 8) and displaying a list alternative Care Plan elements. If the clinician determines in step 416 that the proposed Care Plan elements are acceptable and the Care Plan is complete for the selected diagnosis, he then determines in step 418 whether the proposed Care Plan displayed in CareGrid™ interface 30 is an overall complete Care Plan for the patient. If the proposed Care Plan is not an overall complete Care Plan for the patient, the clinician returns to step 300 (FIG. 7A) to select one or more additional diagnoses. At any time before accepting the plan the clinician can change any of the previously selected or proposed diagnoses or Care Plan elements.

If the proposed Care Plan is an appropriate overall, complete Care Plan for the patient, the clinician signals his acceptance by clicking on an “Accept” button 103 (FIG. 6) in step 420. In step 422, the Care Plan elements are initiated, as described below in more detail. At least some of the Care Plan elements are preferably initiated automatically.

FIG. 8 shows the steps of a preferred method for selecting alternative or addition Care Plan elements. In step 502, the clinician calls up a display of alternative Care Plan elements, for example, by touching display device 24 at the column heading for the proposed but unacceptable Care Plan element. The displayed Care Plan elements may be grouped in a logical manner and displayed within each group alphabetically or in order of prior usage frequency. In step 504, the clinician accepts one of the displayed alternative Care Plan elements or inputs a Care Plan element using an alphanumeric keypad. In step 506, the program compares the selected Care Plan element with the patient record and authoritative medical guidelines. For example, CareGrid™ engine 78 can also check in step 508 for drug allergies and interactions and the proper drug dosages, based, for example, on the patients weight, age, sex , etc. Other rules-based assessments can also be performed.

If CareGrid™ engine 78 determines in step 508 that the selected Care Plan is inappropriate because it conflicts with something in the patient record or with authoritative guidelines as described above with respect to step 506, a warning is displayed to the clinician in step 512. If the clinician determines in step 514 that the Care Plan element is improper, he decides in step 516 whether to modify a Care Plan element, for example, to change a drug dosage. If he decides to modify a plan element, he modifies the element in step 518. The CareGrid™ engine 78 returns to step 506 and compares the modified plan element with the patient's personal information and basic medical authority. If the clinician decided not to modify the Care Plan in step 516, he returns to step 502 to display alternative Care Plan elements and selects a different Care Plan element.

If no conflict is found in step 508 or the clinician decided in step 514 to accept the Care Plan element despite the warning, the Care Plan element is compared in step 522 to other medical and non-medical authorities' rules. For example, CareGrid™ engine 78 may determine in step 522 whether the patient's insurance company will pay for the selected element in connection with the selected diagnosis. If in step 524, the CareGrid™ engine 78 determines that the Care Plan elements are satisfies the rules, the process returns to step 416 and the clinician determines whether the remaining Care Plan elements are acceptable and that the Care Plan is complete for the selected diagnosis.

If the Care Plan element does not meet one of the rules, the Care Plan element is considered to be non-conforming or unsupported for the selected diagnosis and the clinician is notified in step 526. The clinician can then accept the Care Plan element as non-conforming for the selected diagnosis, chose a different Care Plan element, or chose a diagnosis for which the Care Plan element conforms. For example, the clinician may have selected a test that a payor will not cover in connection with the selected diagnosis. The clinician can order the test anyway, select a different test, or select a more appropriate diagnosis for which the test is covered, the new diagnosis being, at the option of the clinician, in addition to or in place of the previously selected diagnosis.

In step 528, the clinician decides whether to accept the non-conforming Care Plan element. If the clinician accepts the Care Plan element, the CareGrid™ engine 78 returns to step 416 of FIG. 7B and the clinician determines whether the Care Plan is now acceptable and complete for the selected diagnosis. If the clinician does not accept the Care Plan element in step 528, he can select a different Care Plan element or he can select a diagnosis to which the Care Plan element conforms. If the clinician decides in step 530 to select a different Care Plan element, he returns to step 502 and a list of Care Plan elements is displayed for selection.

The clinician may want to retain the selected Care Plan element, and to change the diagnosis to one that supports the element. For example, although two similar diagnoses may both account for the patient's symptoms, the patient's insurance company may cover a desired test for one but not the other. CareGrid™ interface 30 includes a “Select Diagnosis” (not shown) button for selecting a new diagnosis that supports the selected Care Plan element. The button is inactive, typically indicated by being “grayed out,” until a selected Care Grid element is found to be non-confirming in step 524. The button then becomes active. Upon touching the Select Diagnosis button, CareGrid™ engine displays in step 532 diagnoses that support the selected Care Plan element. The clinician selects in step 534 one of the proposed diagnosis that is consistent with the patients condition. Upon selection of a new diagnosis, CareGrid™ engine displays in step 536 the selected diagnosis in CareGrid™ interface 30, replacing the previously selected diagnosis with the newly selected one. The process then continues with step 400 (FIG. 7B), in which the CareGrid™ engine replaces the remaining columns of the CareGrid™ interface with appropriate Care Plan elements for the new diagnosis.

Alternatively, the clinician could select one of the suggested diagnosis as an additional or alternative diagnosis, rather than as a replacement for the previously selected one, with the newly selected diagnosis being inserted on the next row 60 of CareGrid™ interface 30. An alternative diagnosis is useful, for example, when a clinician has a tentative diagnosis that accounts for a patient's symptoms, but wants to order a test to rule out an alternative possible cause of the symptom, but the test is not justified by the tentative diagnosis.

Although as described above, a physician can individually change or select a Care Plan element of a treatment plan, the invention can also provide for selecting a complete alternative Care Plan, that is, a different set of Care Plan elements, rather than changing the Care Plan elements one at a time. For example, one plan could include elements to treat a condition using surgery, whereas an alternative plan could use medication.

The clinician can specify the method used by CareGrid™ engine 78 to determine for any particular column which Care Plan elements are presented and in what order. For example, many clinicians may prefer to use frequency of previous selection to determine which elements are preferred. Others may use medical authority or payor guidelines. If CareGrid™ engine 78 is integrated with a payor database, CareGrid™ engine 78 may order the Care Plan elements in accordance with the guidelines of the payor for the specific patient.

Real-time quality assurance systems can monitor the Care Plan to ensure that it is appropriate, and utilization management systems can review the efficiency of utilization of clinic and other resources. Authorization requests can be generated where necessary.

If in step 502, the clinician touches the heading of column 64 to display alternative laboratory tests by, he can have the CareGrid™ engine 78 display at his option from a list of laboratory tests that are payor approved for the diagnosis or from a list of all laboratory test. If a list of all tests is displayed, next to each test is displayed an icon indicating whether prior approval for the test is unnecessary, required, or unavailable. For example, a ✓ icon may indicate prior approval is unnecessary, a_may indicate that prior authorization is required, and an X icon may indicate that the test is not approval by the payer. If a test is selected that requires a preauthorization, a request for the authorization is preferably automatically initiated.

Similarly, if the clinician displays alternative medications in step 502 when the physician touches the prescription column, he can select a list of payor approved medications or a list of all medications, sorted either alphabetically or by type of medication. If the physician displayed the list of only payor approved drugs, preferred medications are indicated by a ✓ icon, permitted medications are indicated by a $ icon, and medications requiring prior approval are indicated with a_icon. A pop-up window can provide the method required to obtain prior approval. If the physician chooses a list of all medications, the same icons are used, as well an “X” icon to indicate that a medication is not approved by the payor for the diagnosis.

After one diagnosis and a corresponding Care Plan element are acceptable to the clinician in step 416, the physician can enter additional diagnosis on subsequent rows 60 of CareGrid™ interface 30 if the overall care plan for the patient is not yet complete. The physician can enter as many diagnoses as required for the patient by repeating steps 300 through 418 until the Care Plan is complete. A clear button 142 (FIG. 6) clears the CareGrid™ interface 30. After the physician is satisfied with the diagnoses and treatment plan, he signals his acceptance by clicking on an accept button 103 in step 420 (FIG. 7B). Subsequent screens have “replace” and “add” buttons as well as accept button 103 and clear button 142 to allow the user to indicate whether this is a corrected entry or an additional entry to be recorded. Each data entry field is a text box with increment and decrement arrow buttons where the “normal” value is shown by default.

In step 422, the Care Plan elements can be initiated manually by the clinician, or some or all of the plan elements can be initiated automatically, depending upon the level of integration of other medical systems with the system of the invention. The invention provides a great deal of flexibility in integrating and communicating with other health systems. For example, a prescription can be transmitted to the patient's preferred pharmacy. By automatically sending the prescription, the chance of miscommunication errors due to misreading of handwritten prescriptions is eliminated. Moreover, the physician is not required to write the prescription manually, saving him time. Similarly, laboratory tests that are ordered can be transmitted to the patient's preferred medical laboratory, again saving the physician time for writing out the required test and eliminating a source of miscommunication. Similarly, a referral to a specialist can be generated, and automatically sent to the specialist's office for scheduling. Instructions, generated from a database in accordance with the diagnosis and treatment plan can be generated and printed for the patient.

Because the CareGrid™ interface 30 described above is based upon the basic algorithm of the Encounter, it assists the physician in the Encounter, and is useful in virtually every specialty field. By allowing a full range of input methods for Descriptive data—from a paper chart to voice recognition or electronic pen—each physician's unique workflow is preserved. Because tablet 28 will be at the physician's side during the encounter, it can be used to integrated a host of other functions.

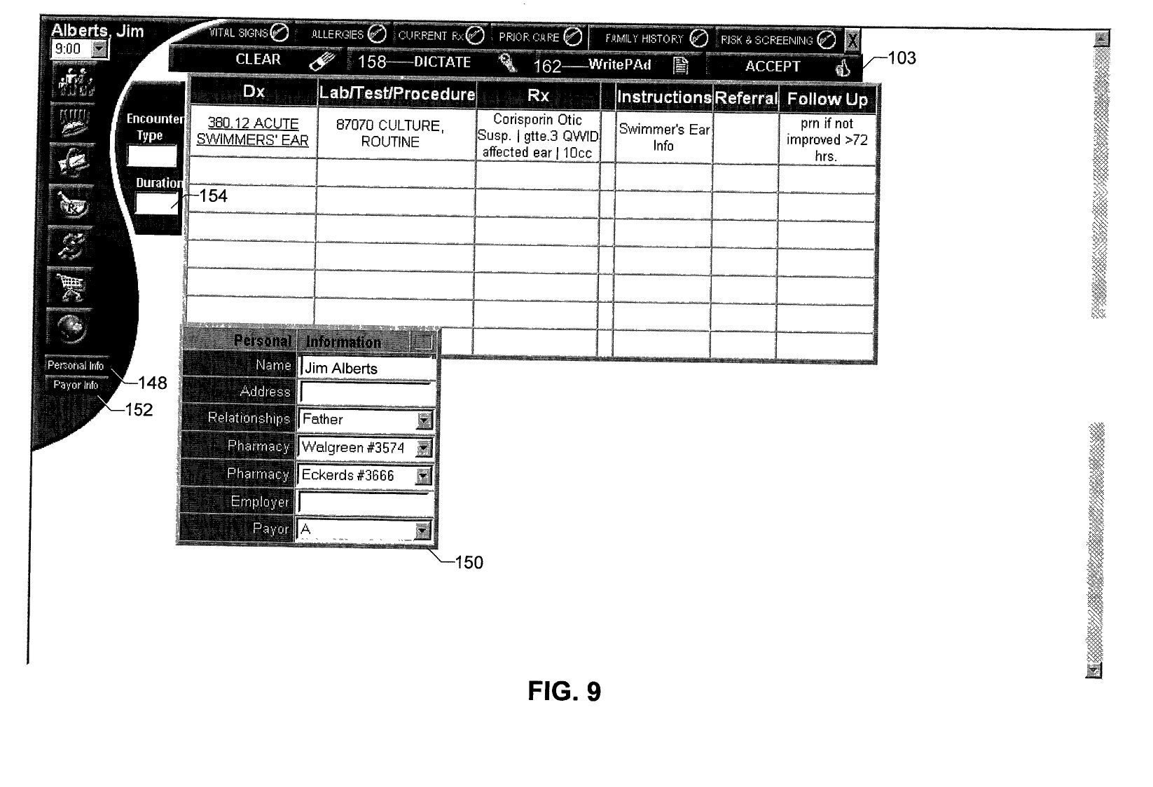

Besides clinician-patient interface 30, the clinician interface screen 58 includes several tools for assisting the clinician in the Encounter. A personal information button 148 displays a patients personal information table 150 as shown in FIG. 9. Upon touching a payor information button 152, tablet 24 displays the payor information, such as name of insurer and type of policy. An encounter box 154 allows the clinician to specify the type of physician-patient encounter and to enter the duration of the Encounter. Types of Encounters include office visits, patient telephone consultations, hospital visits, and telemed consultation. Each type of Encounter can be characterized as initial or established and as brief, intermediate, extended, or comprehensive.

Upon touching a dictate button 158, the physician can dictate into microphone 36 integrated into tablet 28. The dictated speech is converted to text, either by voice recognition program, a stenographer, or a combination of the two. Preferably, the audio data is transmitted over the radio frequency link to clinic server 20. The audio data is converted to text by a voice recognition program and then checked for errors by a stenographer. The text data is transmitted back to tablet 28 for final review and acceptance by the clinician. Alternatively, software in tablet 28 can convert the dictation of text as the words are being dictated, and the physician can accept or correct the text upon completion of the dictation. The digitally captured audio can also be retained as a record. Dictation is the preferred method of capturing data such as patient history, symptoms, and objective findings, that is not readily entered by the clinician without slowing the physician-patient encounter.

Touching a write pad button 162 reveals a screen for handwriting image capture from the user with a stylus. To the side of the write pad image area are icons which the user can use to place graphics for common body parts directly into the image. To facilitate data capture using the writepad, it is formatted with rows entitled: “Chief Complaint ,” “HPI”—History of Present Illness, “PFSH”—Personal Family Social History, Review of Systems, “Physical Exam,” and “Future Treatment Plan.” An accept button (not shown) allows the physician to accept the entered data for incorporation into the patient record.

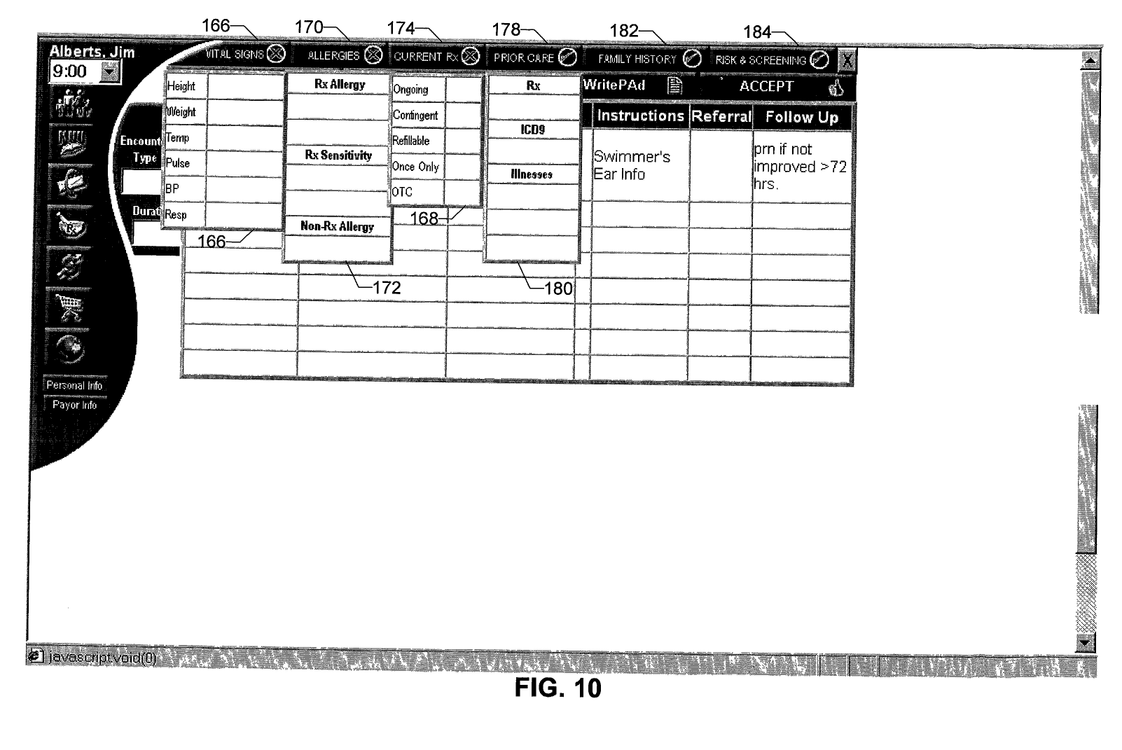

Upon touching the Vital Signs button 166, a vital signs table 168 (FIG. 10) listing the patient's vital signs for the day as measured preferably by a nurse before the physician's examination. When viewed by the physician, the data recorded previously is shown with an adjacent text box for additional or correcting entries. This is preferably a tabbed screen with today's most recent textual data shown by default. The other tab will display the patient's history of vital signs in a graph with a selectable date range to display with one year being the default.

When an Allergies button 170 is touched, allergy data captured from previous physician-patient encounters is displayed in an allergy data table 172. Upon touching a current prescription button 174, a medications table 176 showing medications currently prescribed, and optionally, previously prescribed to this patient. Medications table 176 displays the medication, dosage, frequency and status (“Refillable” or “Once only.” If “Refillable” medications table 176 shows whether this is “Chronic.” ) and the expected date the prescribed supply including refills will be exhausted. “Refillable” medications also have another push button to display the review criteria. The dosage and frequency information may be changed to reflect what the patient is actually taking and the changed data will display in a different color, such as yellow. This will also show up in yellow on the CareGrid™ interface 30 and require a separate “Accept” to approve the new dosage.

Medications prescribed through the using physician's office will display automatically. There will be a blank line at the bottom of the list of current medications for entry of medications prescribed elsewhere. When the new entry is completed, a new blank line will display at the end of the list. Additional space for self-prescribed over the counter vitamins, supplements etc. (OTCs) should be provided. Previously recorded OTCs will be shown with the ability to retain or discard. The last line of the OTC display will always be blank allowing entry of an OTC the patient has just advised they are taking. When this blank entry is filled, a new blank entry will appear below.

The user must “Accept” new entries and changes to record them. The text for outdated entries may be deleted prior to “Accept.” At the bottom of the list can be two buttons (not shown): “Current” and “Prior” to display only current medications or to allow adding a list of prior medications. To the right of “Prior” is “X months” to specify the time period of interest. A medication (or OTC) meets the “Prior” criteria if its supply exhausted during the number of months specified prior to today's date.

At the bottom of the list is a separate button allowing the user to enter the number of months to define “previously” prescribed as the time since the prescribed supply was exhausted. When pushed, a small dialog box will pop up: “Show all medications currently prescribed and whose supply has exhausted in the last X months.” Default value is zero when the list of medications is first visited. Entering a new value and leaving the text box will cause the pop up to disappear and the list to refresh.

Many health insurance programs now use Pharmacy Benefits Managers (PBMs) for chronic medications. These PBMs will not allow the patient to request a refill until the supply is nearly gone. This frequently causes a short-supply problem as the patient only has a narrow window in which to order refills before the supply will exhaust. The inventive system can offer patients a refill reminder service or even do it for them by e-mail or fax to tell a patient on the day a refill may be requested from the PBM.

Upon selecting a prior care button 178, prior illnesses are shown in a prior care table 180. The prior care button 178 allows the display of chronic illnesses, acute illnesses, or both. If chronic illnesses are selected, chronic illnesses will be displayed. Adjacent to each chronic illness is a button that will transfer that diagnosis to the clinician interface for today's encounter. Upon selection of an “Acute” button, all acute illnesses and their date, including ICD codes if desired, and descriptions with a blank at the bottom for patient supplied information. At the top of the list are blanks to enter the date range of interest with only current entries by default. Item of different types may be displayed in different colors, such as either green or black text to indicate whether this illness was treated in this office or by an outside health care provider. Double-clicking on a green entry (this office) will show the complete encounter.

Using a “Request History From Another Office Button” (not shown), it is possible to request that another health care provider send you their information about this patient. For this function to be usable, the patient must have supplied the name of the health care provider in question and a release, which may be entered at the time the patient first registers if allowed by law. The request for more information is then forwarded to that health care provider along with an image of the patient release. The inventive system maintains a directory of health care providers, their e-mail addresses and fax numbers. If the health care provider is using the system, this request and the response is transmitted electronically. Otherwise, it is faxed.

After sending, a pop-up box is displayed which indicates that the request has been cued electronically to another StatNet™ network subscriber or sent by a fax to an off-network provider. The user will be notified of any electronic response.

Upon selection of a family history button 182, the patient's family history is displayed. Upon selection of a risk and screening button 184, illnesses for which the patient is at risk or should undergo screening tests are listed.

These risks may be determined by patients' demographics as well as by past history, family history and other information entered by the clinician or determined via expert system software.

Non-Patient Care Functions

The following are non-patient specific services, which can be accessed whether or not a patient is selected.

Medical References

FIG. 4 shows below the patient care button 42, a medical references button 190. Upon touching medical references button 190, a list of on-line medical references are presented to the physician for his review. The references could include, for example, Merck, Medline, Scientific American Medicine, and Authorities including CDCP, AMA and others. References for prescriptions include PDR, MPR. References could also include Expert Software for determining, for example, correct Dosage software, and Cost of Care. Lastly, references could include conversion between CPT and ICD diagnosis.

Communications Functions

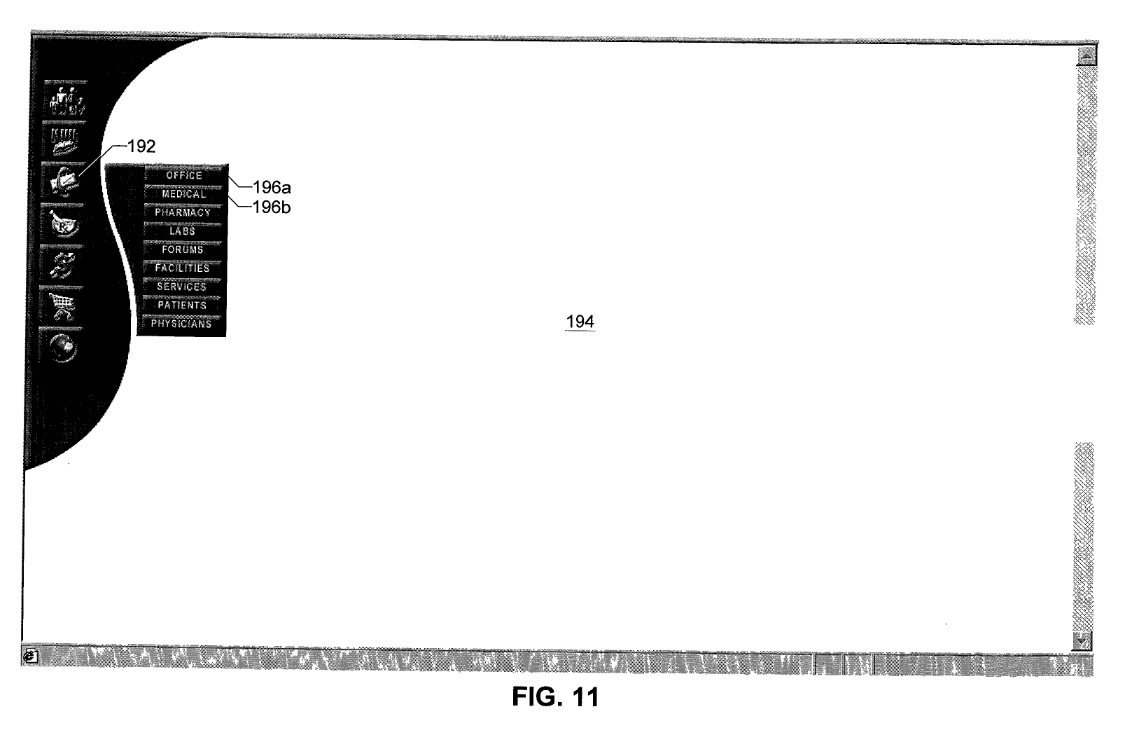

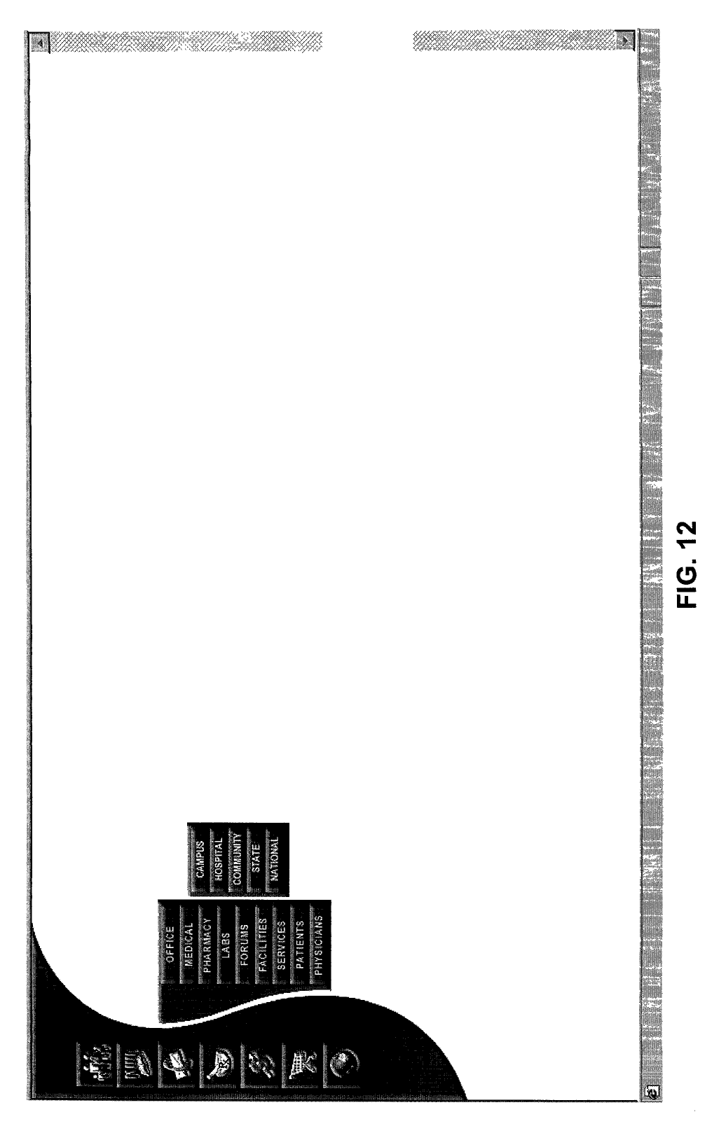

FIG. 11 shows a screen 194 that is presented when the physician selects a communication button 192 from introductory image 40. FIG. 12 shows that communication features can also be accessed while using CareGrid™ interface 30. FIG. 11 shows that the physician is presented with a communications button 196a for communication within the clinic campus, a communications button 196b for communication to and from one or more hospitals, a communications button 196c for communicating with the greater community, a communications button 196d for sending and receiving electronic mail, a communications button 196e for participating in forums, a communications button 196f for communicating with pharmacies, a communications button 196g for communicating with laboratories, a communications button 196h for paging others, and a communications button 196i for accessing general on-line services.

When communications button 196h is touched, a paging screen 198 is presented, allowing the physician to page any number of health care personnel for assistance. For example, paging screen 198 includes a paging button 200a for paging a nurse, a paging button 200b for paging an assistant, a paging button 200c for paging a receptionist, and a paging button 200d for paging an administrative assistant. Upon depressing any of paging button 200, a paging window 202 is opened, allowing the physician to write a paging message in a message window 204, if desired, and to specify whether the page is to be marked urgent by either a send button 206 or a send urgent button208.

The communication page also includes contact information for patients, and specialists. Information regarding specialists includes specialty, name, address, map tools to provide the patient with directions to the specialists office from office the physician's office or the patient's home, work, or other address.

The information also includes restrictions, such as subspecialty, hours, interests, accepting new patients, etc. The coverage of the specialist, such as the on-call schedule and the call group are provided, as well as payor contracts.

Batch Prescription Refills

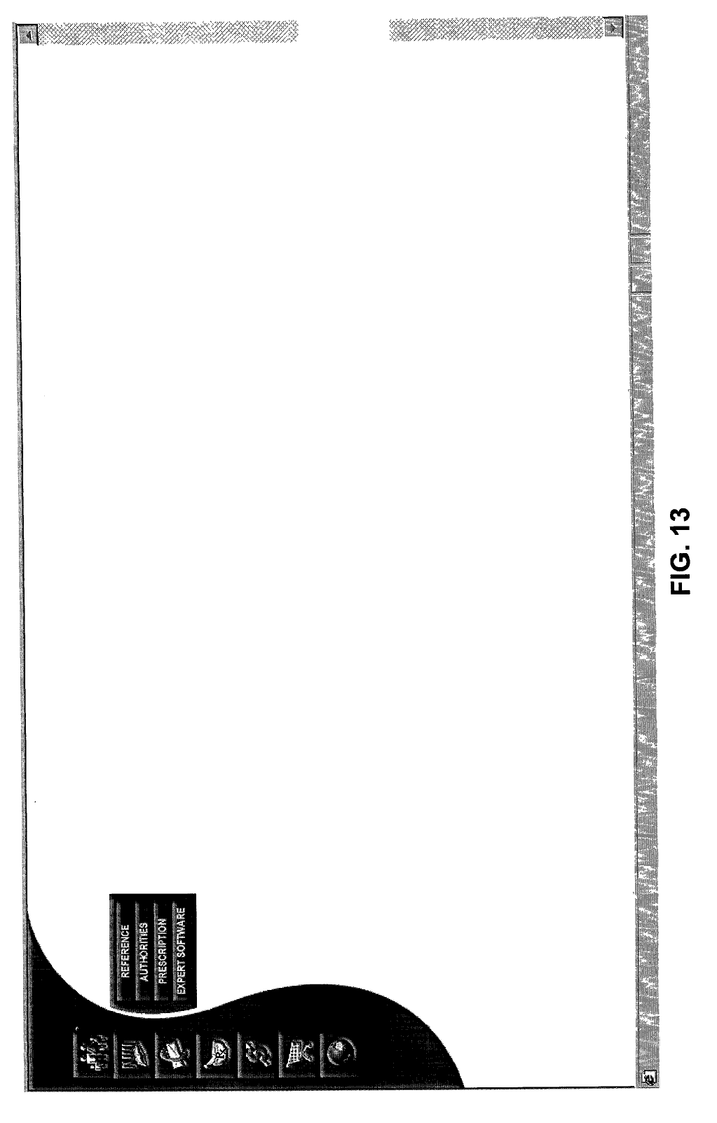

Upon pressing the Prescription Button 212, a chart is presented as shown in FIG. 13 including Patient's name, Drug, Dose, Frequency, Number, and Refills. The chart also includes screening information, including disease-based, drug-based, routine, or physician-defined screening. Authorization information includes Payor Approved (Formulary), Preferred (Check icon),Permitted (Dollar sign icon), or Prior Authorization Required (Triangle warning icon) When this category is selected, before providing a list of these drugs, a pop-up window provides the method required to gain prior approval. If a drug chosen from a list of all medications, medications that are not payor approved will be labeled with an X icon.

Payor Information

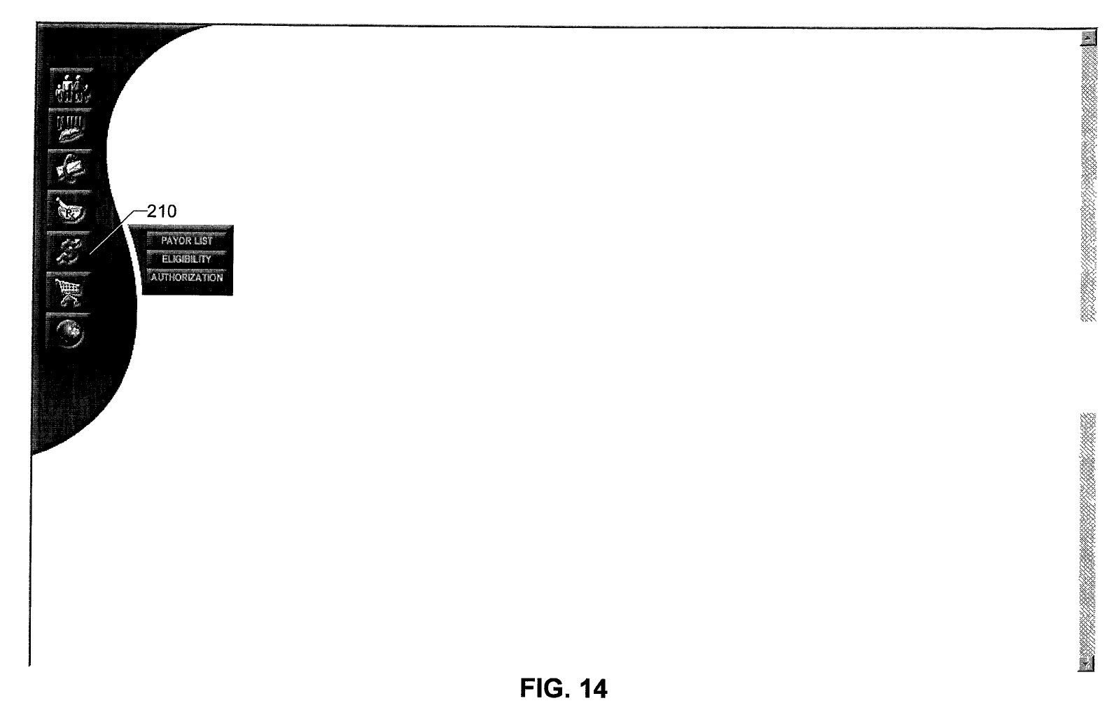

Upon touching a general payor information button 210, buttons as shown in FIG. 14 are displayed for providing the payor information to the clinician, including a payor list that includes all payors on the system, an eligibility list, that describes the coverage of the plans of each payor, and an authorization button, that describes the authorizations required before incurring various expenses. Upon selected an individual payor, information about the payor, including its coverage, preferred treatments, etc. are displayed.

Good and Services

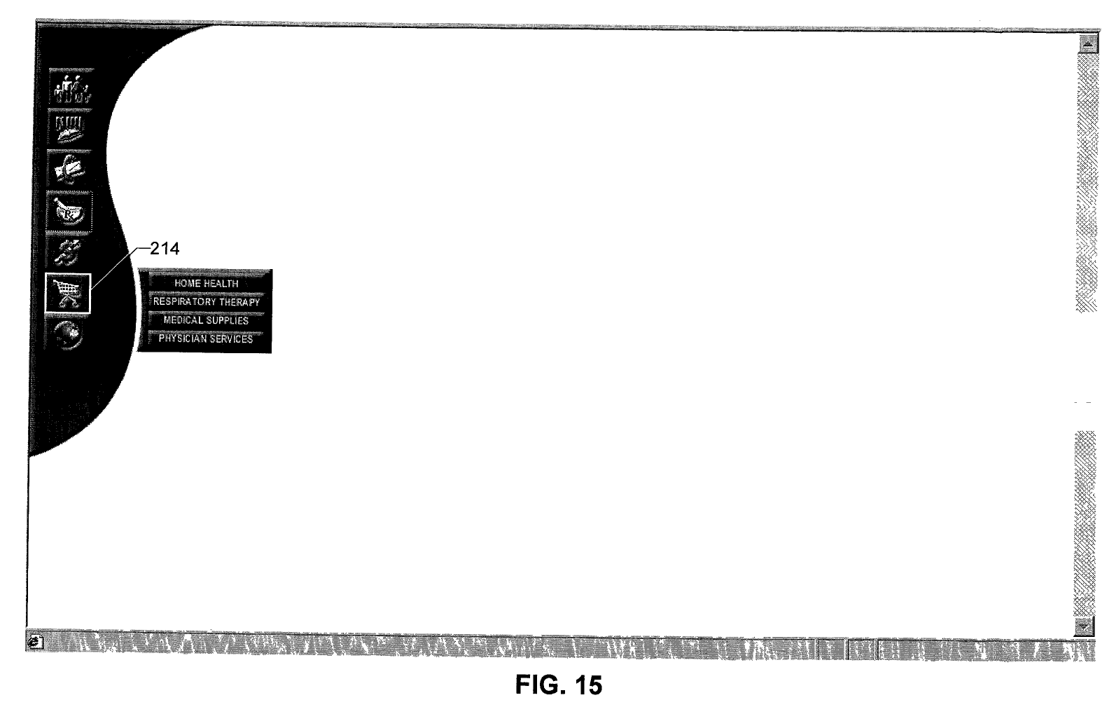

Upon touching a goods and services button 214, a goods and services buttons as shown in FIG. 15 are displayed to provide links to various vendors of goods and services that are of interest to the physician. The vendors can be charged for placing their links on the page and for advertising space on this page or other pages. Charges can be determined by various methods, including the number of click-throughs, the goods or services sold through click-throughs, etc.

News

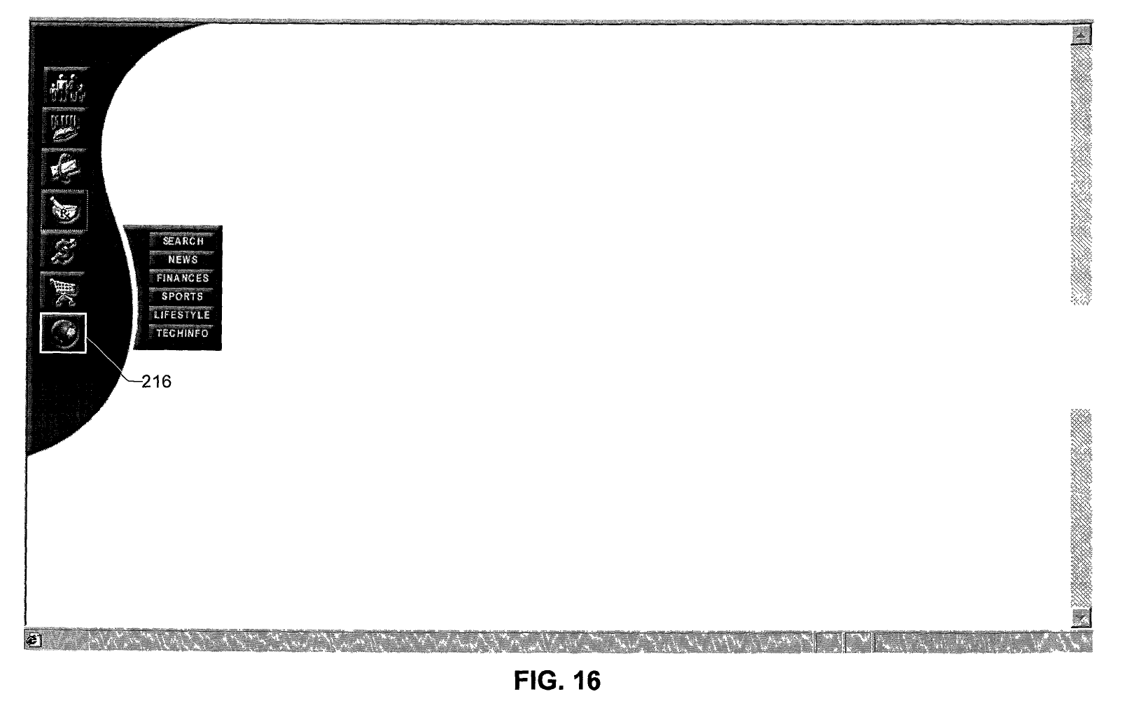

A news button 216 when touched provides the physician with a news links as shown in FIG. 16 that display articles of medical interest to the physician. The news page can be customized to show the physician's favorite journals, or news from a non-medical source specified by the physician. The news page could also include forms.

Network Model

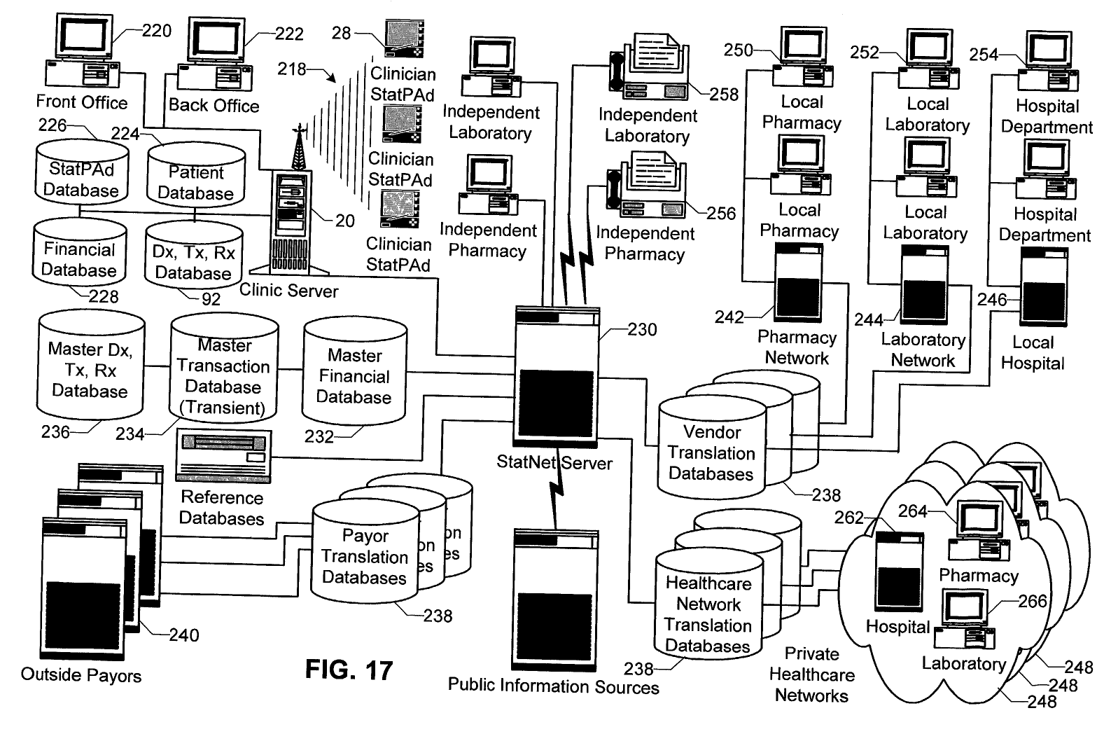

FIG. 17 shows multiple clinician interface devices, in this embodiment, StatPAd™ access devices or tablets 28, communicating using a radio frequency link 218 to a clinic server 20. The clinic server 20 is in data communication with a front office computer 220 and a back office computer 222. The front office computer is typically used to check in patients, prepare bills, etc. while the back office computer is more typically used for reference, medical file review, Rx refills, etc. Both front office computer 220 and a back office computer 222 can perform the same functions and both will interact with the insurance payers for authorizations, referrals, etc. The clinic server also maintains several database including a patient database 224, a StatPAd™ access device database 226, a financial database 228, and a diagnosis/treatment/prescription database 92, all of which may be for example, relational databases of the type commercially available from Oracle Corporation, Redwood Shores, Calif. The StatPAd™ access device database 226 includes operational data used to guide the StatPAd™ access device program. The patient database 224 includes a medical and insurance information about all patients treated in the clinic. All information in the system is subject to security measures including physical, electronic and programmatic security means.). Financial database 228 includes billing records for the clinic. The diagnosis/treatment/prescription database 92 includes diagnosis, treatment, prescription information. This information includes description and codes for diagnoses and the Care Plan elements, including diagnostic procedures, drug prescriptions, etc. associated with the diagnoses.

A CareGrid™ engine 78 operating on clinic server 20 accesses patient database 224, StatPAd™ access device database 226, and diagnosis/treatment/prescription database 92 to provide the patient care functions described above. CareGrid™ engine 78 is preferably written in an object oriented language, such as C++. Skilled computer programmers would be able to create CareGrid™ engine 78 to carry out the functionality described above.

A StatNet™ network server 230 provides information and co nmnunications services to clinic servers 20 in multiple clinics. For example, clinic server 20 includes a master financial database 232, a master transaction database 234 and a master diagnosis/treatment/prescription database 236. These databases are used to update the corresponding databases on clinic servers 20 in the individual clinics.

StatNet™ network server 230 also maintains translation databases 238 that allow StatNet™ network server 230 to communicate with outside service and information providers, such as outside payors 240, pharmacy networks 242, laboratory networks 244, hospitals 246, and private healthcare networks 248. Thus, each individual clinic does not need to maintain compatibility with a wide number of outside service and information providers. Periodically, the StatNet™ network server 230 will receive updates from insurance companies regarding their rules for regarding their preferred treatments and coverage, including, for example, formulary for payment of prescription medication and contract rules for referrals. Alternatively, StatNet™ network server 230 could receive live updates on line.

Pharmacy networks 242, laboratory networks 244, hospitals 246 communicate with their individual member pharmacies 250, laboratory 252, and departments 254, respectively. The StatNet™ network server 230 also communicates with independent pharmacies 256 and independent laboratories 258 directly when possible or by fax if no electronic connection is available, as well as with private health care networks 248 that may include their own hospitals 262, pharmacies 264, and laboratories 266.

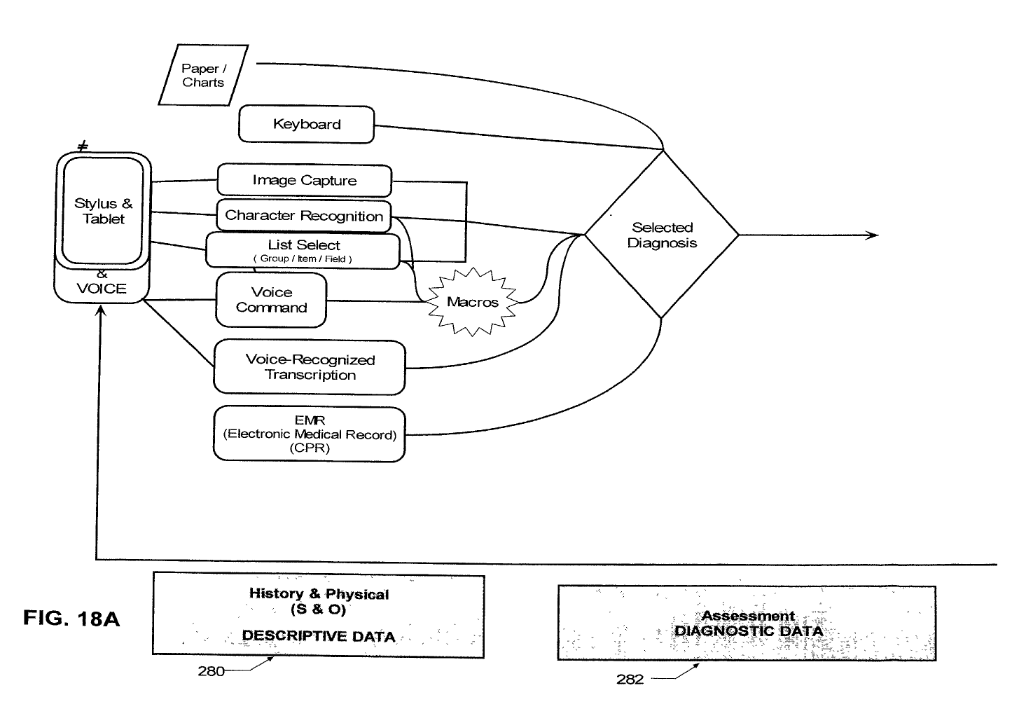

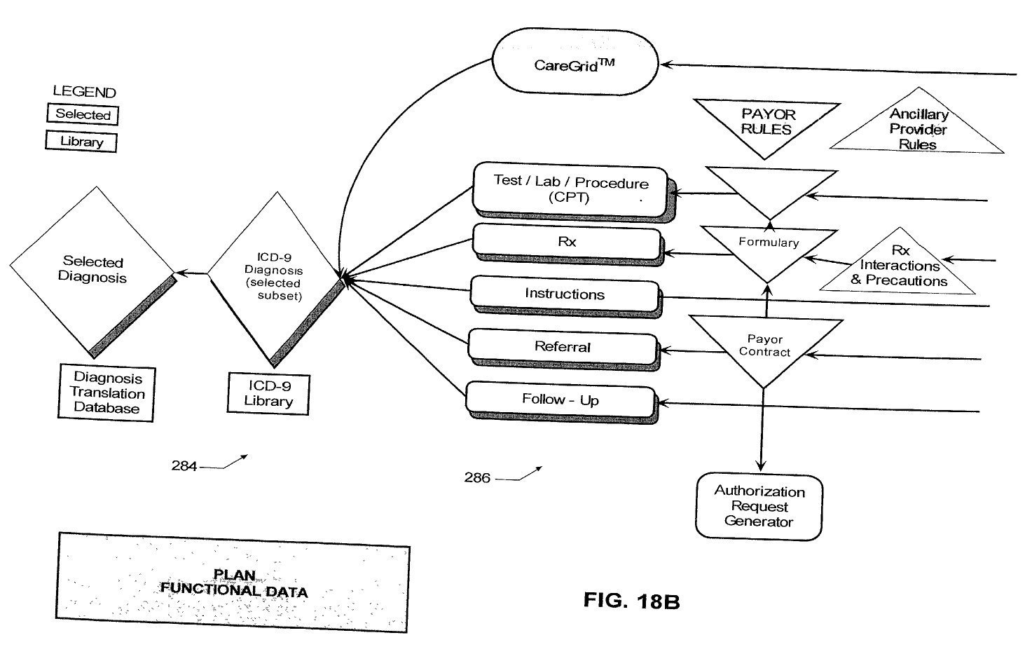

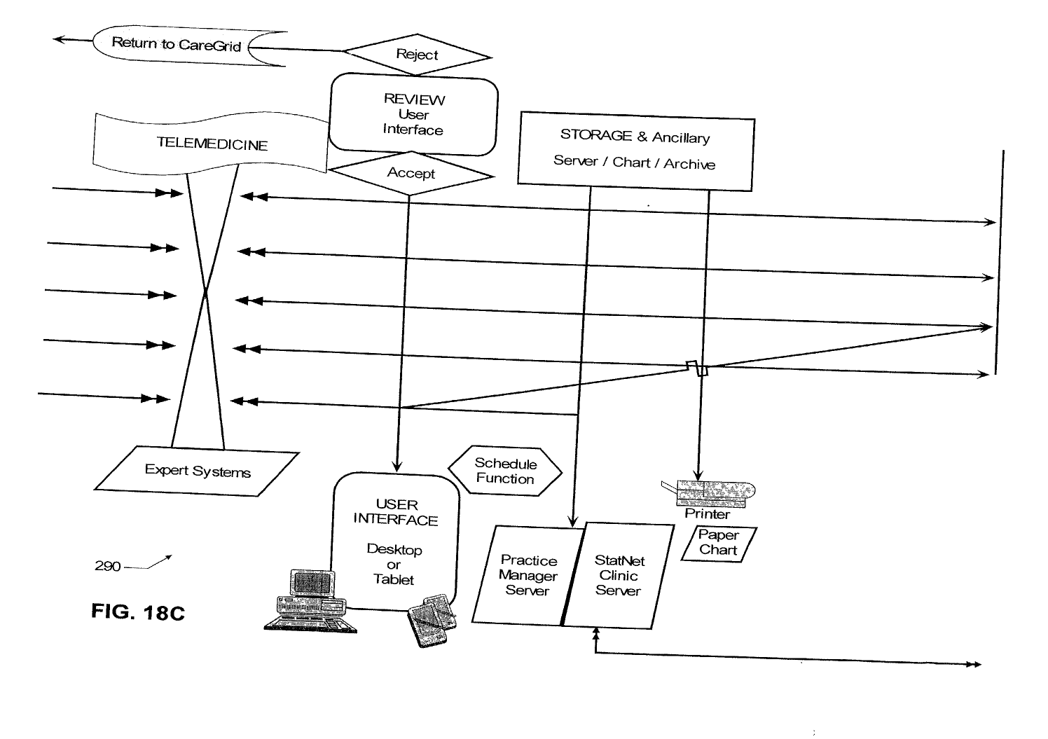

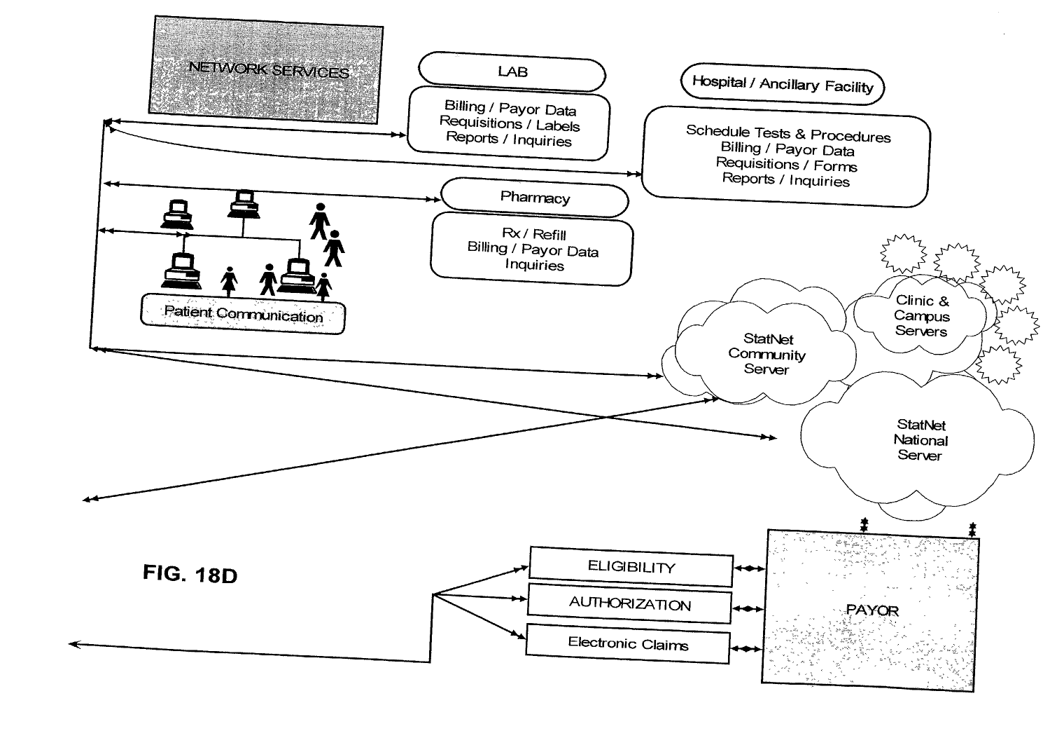

FIG. 18A, 18B, 18C and 18D show the overall flow a system of the invention. In section 280 of FIG. 18A, the physician obtains descriptive data, including historical and physical information, such as symptoms and objective findings, and from the patient and from a variety of information sources using a variety of tools. For example, the physician will typically examine the patient and review electronic or paper medical records. The clinician will also typically record new information using any of a variety of tools, including voice or character recognition, keyboard, handwriting image capture or simply list selection, and a touch-sensitive screen.

After reviewing the symptoms and objective finding, the physician in section 282 applies his knowledge and skill in assessing the information to determine a diagnosis. In section 284 of FIG. 18B, the diagnosis, if colloquial, is converted to a formal diagnosis using a diagnosis translate database and a library of formal diagnoses. From the formal diagnosis, the CareGrid™ matrix is constructed in section 286. Care plan items, including laboratory and other tests, procedures, prescriptions, instructions, referrals, and follow up actions are proposed by the system in accordance with medical authorities, payor rules, and ancillary provider rules. Medications are checked in accordance with payor formulary and for allergies, correct dosage, and other precautions. Referrals are checked for payor contract requirements and guidelines, as well as contractual relationship of consultant or facility. Any payor authorizations required are automatically generated. The system provides to the clinician in an orderly manner a wide variety of information to assist him in arriving at an appropriate and diagnosis and Care Plan, as well as ascertain that payors guidelines allow all facets of the Care Plan. The clinician can go through several iterations, back and forth, of amending the diagnosis and the Care Plan elements until the physician is satisfied that the chosen diagnosis and Care Plan will be ethical, accurate and—nevertheless—acceptable to that payors guidelines for payment. The system prints any required paperwork and interfaces with Practice management software (PMS) to store necessary patient information. The clinic staff may use StatPAd™ access device's scheduling agent alone or in combination with that of the PMS to arrange follow-up and subsequent visits.

In section 290 of FIG. 18C, the clinician can accept or reject the care plan using the clinician interface and necessary information can be printed and/or stored. In section 292 of FIG. 18D, requests are sent to outside providers, including laboratories, pharmacies and hospitals. Information sent to laboratories includes billing information, payor data, requisitions, labels, reports, and inquiries. Information sent to hospitals and ancillary facilities includes scheduling test and procedures, billing data, payor data, requisitions, forms, reports, and inquiries. Information sent to pharmacies includes prescription and refill information, billing and payor data and inquiries. The office computer is connected to the StatNet™ network community and national servers, which are connected to all aspects of medical and patient information, including payors. The office computer is also directed in electronic communications with the payors for determining eligibility, obtaining authorization, and filing claims.

Usability Enhancements

To be adopted by busy clinicians, the system must be as easy to use and helpful as possible. The following features increase the useability of the system. When the user's finger touch/cursor touches the area offering additional information, a new window pops up with that information. Any movement off the original area offering additional information removes the pop-up window. For screens which have many areas offering additional information which may be needed more than transiently, there will be a blank area on that screen where each item's additional information can be displayed when requested until displaced by the next request for additional information. This is similar to a tabbed form.

Many lists of information must allow the entry of additional items to the list. In these cases, the list of existing information will be displayed with one blank entry at the bottom. The user may then enter the data into that blank entry, causing another blank entry to appear below. Wherever a numerical value must be entered, it should default to a “normal” or zero value, may be directly keyed or written in, and allow incrementing and decrementing via push-button.

Each screen will have space reserved for pertinent advertising and related information in an area that doesn't disrupt ergonomic use of the StatPAd™ access device software and device whenever practical. This advertising will become the screen saver when the screen saver is activated.

There are frequent needs to share patient information between health care providers. This sharing of information must be authorized by the patient and other interested parties. Each patient is typically asked to sign a release document or electronically authorize either limited or unlimited access to his medical information from other providers. This release will be scanned into the system and /or recorded as part of the patient records. Whenever information from another health care provider is required, the system will send (fax or electronic) that provider the patient's authorization. The other health care provider will then “push” the information to the requester. Limitations may require subsequent reauthorization for certain data.

Integration with Electronic Medical Records Systems and certain other Software

The CareGrid™ clinician interface of the present invention can be integrated into existing electronic medical record systems. In one implementation, the clinician uses CareGrid™ interface 30 and CareGrid™ engine 78 provides information, such as Care Plan elements and their implementation, directly to the existing electronic medical records (EMR) system and may alternate between each software, using the StatPAd™ access device software both to increase efficiency of the EMR as well as automate the tasks associated with the encounter, which the EMR software doesn't do.

In another implementation CareGrid™ engine 78 operates largely in the background. The physician continues to enter information into his existing electronic medical records software, and CareGrid™ engine 78 provides in the background the functionality described above and returns the information to appropriate places in the existing electronic medical records system. Thus, the physician can continue to use an existing interface with which he is familiar, but is provided the enhanced functionality of the present invention.

Integration with Expert System and other medical software may also be provided.

For example, some systems require the physician to enter symptoms, and then provides the physician with possible diagnoses to select. The selected diagnosis can be read by CareGrid™ engine 78 and Care Plan elements suggested and implemented as described above, with the Care Plan items being recorded into the existing software. Optionally such systems may operate invisibly in the background, seamlessly integrated into StatPAd™ access device software.

By providing an electronic tool into the hands of the clinician during the Encounter, the present invention allows real-time quality (does “control” work better for the patent office? MDs would hate it.) and efficiency guidance. Because the present invention assists rather than burdens the clinician, he will use the system during the physician-patient encounter, so the diagnostic and treatment information are available electronically for automatic checking. Moreover, by providing the physician with authoritative guidelines for diagnoses and treatments, a standard level of care is provided. The physician is not constrained, however, to any diagnosis or treatment presented by the system. The physician is always free to enter the diagnosis and treatment elements that he deems appropriate.

Although the invention is illustrated above in the Detailed Description of the Preferred Embodiments and in the Background and Summary of the Invention sections by describing a system with many parts and aspects, the invention can be embodied in a variety of implementations to suit the needs of the user. Not every implementation will include every part or aspect described above and not every implementation will accomplish all of the objects of the invention. Also, many of the parts may be separately patentable.

Although the present invention and its advantages have been described in detail, it should be understood that the system and software represent the archetype software system for healthcare providers that can efficiently and ergonomically integrate other forms of medical software. Moreover, StatPAd™ access device software has proven able to allow adaptation to other healthcare business structures such as those in other countries where methods are unique and fundamentally different. For these reasons, various changes, substitutions and alterations may be made herein without departing from the spirit and scope of the invention as defined by the appended claims. Moreover, the scope of the present application is not intended to be limited to the particular embodiments of the process, machine, manufacture. composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A method of enhancing the quality and efficiency of the clinician-patient encounter, the method dependent upon differentiation of two types of data resulting from the clinician-patient encounter, the method comprising:
obtaining descriptive data to enable a clinician to determine a diagnosis;
determining a diagnosis;
entering the diagnosis into an electronic system wherein entry of the descriptive data in an electronic format is not a prerequisite for entering a diagnosis;
automatically determining a proposed plan of action consistent with the diagnosis, the proposed plan of action including one or more elements;
electronically displaying the proposed plan of action composed of functional data;
if the proposed plan of action is acceptable to the clinician, accepting the plan of action; and
if the proposed plan of action is not acceptable to the clinician, altering or adding to the one or more elements until in order to make them acceptable for the care of a specific patient,
wherein the method differentiates between descriptive data and functional data, the descriptive data regarding the patient's history, symptoms and physical examination findings being used by the clinician to form the diagnosis, but only function data being required to be entered into the electronic system to determine a plan of action.

2. The method of claim 1 further comprising automatically initiating one or more of the action plan elements.

3. The method of claim 1 in which entering the diagnosis into the electronic system includes:
entering a colloquial diagnosis into the electronic system;
determining from the colloquial diagnosis a formal diagnosis; and
associating the formal diagnosis with said colloquial diagnosis for future use.

4. The method of claim 1 wherein selecting one or more elements of the plan of action in which altering or adding to the one or more elements until in order to make them acceptable for the care of a specific patient includes:
automatically determining whether each the altered or added action plan element is authorized for the entered diagnosis by a payor or other authority; and
if the care plan element is not authorized by the payor for the entered diagnosis, automatically suggesting one or more alternative diagnoses for which the care plan element is authorized, thereby allowing a clinician to converge between a diagnosis and plan of action.

5. A system enhancing the quality and efficiency of the clinician-patient encounter, comprising:
an output device for displaying to a clinician, health-related information, including diagnostic and care plan information;
an input device for entering diagnostic and care plan information;
a memory for storing a computer program;
a processor for executing the computer program, the computer program enhancing the quality and efficiency the clinician-patient encounter by:
accepting from the clinician a diagnosis entered through the input device;
automatically displaying care plan elements consistent with the diagnosis, the care plan elements being arranged in a specific order designated by the clinician and/or an authority;
accepting from the clinician a selection of one or more alternate or additional care plan elements; and
following review and acceptance by the clinician and/or authoritative electronic systems, automatically initiating at least one aspect of the selected care plan elements.

6. The system of claim 5 in which care plan elements are displayed in an order determined by the frequency of previous selections by the clinician, an order predefined by the clinician, or an order in accordance with a selected medical authority.

7. The system of claim 5 in which the program adaptively modifies the order of care plan options to reflect choices made by the clinician.

8. The system of claim 5 in which accepting from the clinician a selection of one or more care plan elements includes accepting the selection of one or more of the displayed care plan elements.

9. The system of claim 5 in which accepting from the clinician a selection of one or more care plan elements includes selecting a revised or additional care plan element or accepting a care plan element that is entered by the clinician and that is not one of the displayed care plan elements.

10. The system of claim 9 in which the program further determines whether each entered care plan element is supported by a payor for the entered diagnosis and, if not, displays for selection by the clinician at least one alternative diagnosis for which the payor will support the care plan element(s).

11. The system of claim 5 in which the input device and the output device are positioned on a handheld computer.

12. The system of claim 11 in which the handheld computer includes a wireless communications link to a computer network.

13. The system of claim 12 in which the handheld computer further includes a microphone for verbally inputting patient descriptive data, the verbally input data being transmitted over the wireless communications link to a computer network for transcription or storage.

14. The system of claim 1 in which the transcribed verbally input data is downloaded to the handheld computing device for review by the clinician.

15. The system of claim 5 in which the program supports one or more applications programming interfaces for communicating with other health-care related programs.

16. The system of claim 5 in which the program communicates with databases accessible through a computer network, thereby permitting the program to recall information from the databases and display the information on the output device.

17. The system of claim 16 in which the database include a medical records database, a payor formulary database and other medical and patient information databases.

18. The system of claim 16 in which the program automatically initiates at least one aspect of the selected care plan by communicating with healthcare service provider programs.

19. The system of claim 18 in which the service provider program includes one or more pharmacy programs or medical laboratory programs.

20. The system of claim 5 in which the program includes instructions for initiating a page for a clinician's assistant or coworker.

21. The system of claim 16 in which the program causes the display to display patient-related health information upon request of the clinician.

22. The system of claim 16 in which the program allows entry of vital sign or other measured patient data manually or via electronic interface into the system.

23. The system of claim 16 in which the program causes the display to display the patient's vital signs upon request of the clinician.

24. The system of claim 5 in which the display displays advertisements for products or services related to the patient care details as selected by the clinician.

25. The system of claim 24 in which the advertisements are determined by the user's professional practice, specialty, location and/or personal interests.

26. The system of claim 25 in which the advertisements are further determined in a context-based manner based on interaction of the clinician with the system

27. A method for providing guidance to a clinician for determining a diagnosis and selecting treatments based on authoritative guidelines without constraining the independent practice of medicine by the clinician, comprising:
determining a patient's symptoms;
entering a working diagnosis into an electronic device in data communications with a database associating payor authorized diagnostic and treatment procedures with diagnoses;
automatically generating from the information in the database a diagnostic and treatment procedure action list corresponding to the working diagnosis; and
selecting one or more treatments from the list or entering a treatment not on the list.

28. The method of claim 27 farther comprising determining whether an entered treatment is approved by the payor for the working diagnosis and, if the entered diagnosis is not approved, automatically generating a list of one or more related diagnoses for which the selected treatment is approved and permitting selection of a working diagnosis consistent with the patient's manifestations and authorization by a payor.

29. The method of claim 27 in which:
entering a working diagnosis into a portable electronic device includes transmitting the tentative working diagnosis over a communications link to a computer network; and
automatically generating one or more treatment lists from the information in the database includes automatically generating diagnostic procedure and treatment lists from information stored in a database connected to the computer network and located apart from the portable electronic device.

30. The method of claim 27 in which:
entering a working diagnosis includes entering a colloquial diagnosis used by the clinician and further comprising converting the colloquial diagnosis to a formal diagnosis and automatically generating a diagnostic treatment procedure corresponding to the formal diagnosis; and
automatically generating a diagnostic and treatment list includes generating a diagnostic and treatment list corresponding to the formal diagnosis, thereby allowing the clinician to use his or her preferred colloquial diagnosis while generating the treatment list based on a formal diagnosis.

31. The method of claim 27 in which automatically generating a list in order of preference of treatments includes ordering the list of treatments in accordance with frequency of selection by the clinician, clinician's predefined choices, or payor recommended treatment for the diagnosis.

32. The method of claim 27 further comprising dictating into an audio recorder patient description information.

33. The method of claim 32 further comprising electronically converting the recorded patient description information into text using a voice recognition program.

34. The method of claim 33 further comprising transmitting the recorded patient description information over a communications link to a network computer for converting the recorded patient description information.

35. The method of claim 33 further comprising manually verifying and correcting as necessary the automatic transcription by authorized medical transcriptionists or the clinician.

36. The method of claim 27 further comprising communicating with a patient medical records database to provide patient history.

37. The method of claim 27 further comprising retrieving and displaying patient vital signs.

38. The method of claim 27 in which a selected treatment includes a medication and further comprising indicating to the clinician if the prescribed medication is contraindicated.

39. A system for the collecting, integrating, and communicating information related to providing health care, the system linking the clinician with medical records, payor guidelines, reference information, and service providers, comprising:
an office computer in data communications with one or more computer networks;
a handheld or other portable computing device including an input device and a display device for use by a clinician during a patient encounter, the handheld portable computing device in data communication with the computer network;
a memory in data communication with the handheld computing device and storing a program that assists the Encounter by:
retrieving patient history information from a database accessible from one of the one or more computer networks and causing the patient history to be displayed on the handheld portable computing device;
prompting the clinician to input a diagnosis,
displaying treatment options consistent with the diagnosis, the treatment options being arranged in an order of preference corresponding to the likelihood of selection by the clinician;
selecting a treatment; and
communicating over the computer network to initiate at least a part of the treatment by a health care provider.

40. The method of claim 39 in which selecting a treatment includes prescribing a medication and in which communicating over the computer network to initiate at least a part of the treatment includes transmitting a prescription to a pharmacy service

41. The method of claim 39 further comprising:
accepting a colloquial diagnosis in the clinician's preferred nomenclature; and
associating with the colloquial diagnosis a formal diagnosis consistent with standardized nomenclature; and in which
displaying treatment options consistent with the diagnosis includes displaying treatment options consistent with the formal diagnosis.

42. The method of claim 39 in which the program communicates over the computer network to effectuate the treatment by a health care provider includes transmitting formal requests, orders and associated labels, forms and/or form data for laboratory, radiology, therapy and other healthcare tests, procedures and treatments to laboratories, departments, facilities or individuals.

43. The system of claim 39 in which the program;
receives a treatment selected by the clinician; and notifying the user and displaying alternative diagnoses acceptable to pertinent authorities if the treatment selected by the clinician is not justified by the diagnosis (in the rules used by said authorities.

44. A method of increasing the efficiency of the clinician-patient provision of medical service, comprising:
presenting to a clinician a list of diagnoses;
selecting a diagnosis;
presenting to the clinician a list of actions consistent with the diagnosis;
selecting one or more actions from the list of actions; and
automatically implementing at least one action from the list.

45. A method for assisting a clinician in efficiently and accurately converging to a final diagnosis from a working diagnosis in consideration of a payor or other authority's acceptable guidelines, the method using a graphical user interface that:
presents working diagnoses for selection by a clinician;
selecting a working diagnosis;
displaying for selection by a clinician of a list of one or more Care Plan elements corresponding to the working diagnosis, the care plan elements being determined from payor or other authority's acceptable guideline;
selecting one or more care plan elements from the list or entering a care plan element not on the list;
if a care plan element not on the list is entered, determining whether the care plan element is in accordance with the payor or authority guidelines for the entered diagnosis;
if not, displaying one or more diagnoses that are in accordance with the payor or authority guidelines for the entered care plan element; and
selecting a diagnosis that is in accordance with the patient's symptoms and that supports the entered care plan.
